(19) United States
(12) Patent Application Publication
(10) Pub. No.: US 2026/0187625 A1
(43) Pub. Date: Jul. 2, 2026

(54) CONTEXTUAL DATA TRANSFERS

(71) Applicant: Block, Inc., Oakland, CA (US)

(72) Inventors: Jeremy Mawson, San Francisco, CA (US); Laurence Aderemi, San Francisco, CA (US)

(21) Appl. No.: 19/004,936

(22) Filed: Dec. 30, 2024

Related U.S. Application Data
(63) Continuation of application No. 17/850,918, filed on Jun. 27, 2022, now abandoned.
(60) Provisional application No. 63/284,604, filed on Nov. 30, 2021.

(51) Int. Cl. G06Q 20/38; G06Q 20/32

(52) U.S. Cl. CPC G06Q 20/381; G06Q 20/3223; G06Q 20/389

(57) ABSTRACT

A method includes maintaining a record for a user associated with at least a first asset and a second asset; receiving a request associated with an exchange that identifies the record as a source and an amount of the exchange expressed in a third asset; dynamically determining an optimal conversion path for completing the exchange that specifies a timing for completing the exchange and whether to utilize the first asset or the second asset; when using the first asset, processing the exchange according to the timing and by sending a portion of the first asset to another record associated with the other user, wherein the portion of the first asset sent corresponds to the third asset; and when using the second asset: determining an amount of the second asset that corresponds to the third asset; converting a portion of the second asset to the third asset; and processing the exchange.

### TECHNICAL FIELD

Within electronic data transfer networks, one or more central transfer servers along with various intermediary computing infrastructure and communication networks are used to initiate and perform data transfers between sender devices and receiver devices. In some cases, sender devices and receiver devices for a requested transfer may operate at separate locations, and thus different networks and different subsets of available resources may be available to the different devices within the requested transaction. Moreover, such transfer between different locations or domains may be subject to different rules with respect to risk and compliance depending on sender and recipient locations.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is an example network architecture for facilitating a contextual data transfer between a user and a merchant in accordance with various embodiments of the disclosure;

FIG. 2 is an example network architecture for facilitating a contextual data transfer between a user and another user in accordance with various embodiments of the disclosure;

FIG. 3A is an example user interface (UI) of a payment application depicting a selection between various methods of deposit currencies in accordance with various embodiments of the disclosure;

FIG. 3B is an example UI of a payment application depicting a payment request received by a user in accordance with various embodiments of the disclosure;

FIG. 3C is an example UI of a payment application depicting a selection of a user payment in response to a payment request in accordance with various embodiments of the disclosure;

FIG. 3D is an example UI of a payment application depicting a transaction receipt confirming a transaction between users in accordance with various embodiments of the disclosure;

FIG. 4A is an example UI of a payment application depicting a UI for managing different types of currency from within the payment application in accordance with various embodiments of the disclosure;

FIG. 4B is an example UI of a payment application depicting a UI for managing a first cryptocurrency asset from within the payment application in accordance with various embodiments of the disclosure;

FIG. 4C is an example UI of a payment application depicting a UI for managing a second cryptocurrency asset from within the payment application in accordance with various embodiments of the disclosure;

FIG. 5 is an example method for processing a transaction in accordance with various embodiments of the disclosure;

FIG. 6 is an example method for determining an optimal path for cryptocurrency conversion utilizing context data in accordance with various embodiments of the disclosure;

FIG. 7 is an example method for facilitating transactions through a payment service utilizing available balances in accordance with various embodiments of the disclosure;

FIG. 8 is an environment for facilitating transactions as described herein in accordance with various embodiments of the disclosure;

FIG. 9 is a merchant environment in which contextual data transfers can be performed in accordance with various embodiments of the invention;

FIG. 10 is a peer-to-peer environment in which contextual data transfers can be performed in accordance with various embodiments of the invention;

FIG. 11 depicts a block diagram of a data store that can be associated with one or more payment service servers in accordance with various embodiments of the invention;

FIG. 12 is an integrated transaction environment configured to enable point-of-sale transactions utilizing peer-to-peer assets in accordance with various embodiments of the invention; and

FIG. 13 is a block diagram of a transaction system configured to facilitate contextual data transfers in accordance with various embodiments of the invention.

### DETAILED DESCRIPTION

Techniques described herein relate to contextual data transfers between senders and receivers via associated computing devices within an electronic data transfer network. In an example, such data transfers can involve the intelligent and real-time or near-real-time conversion of assets, for example, as in cross-border or multi-currency transactions. Generally, various intermediary computing infrastructure and communication networks are used to initiate and perform data transfers between sender devices and receiver devices. In some cases, sender devices and receiver devices associated with a data transfer may operate at separate locations or domains with a larger transfer system, and thus different networks and different subsets of available resources may be available to the different devices within the requested transaction. In such existing technologies and disparate systems, lack of interconnectivity of payment rails and exchanges between the intermediary networks significantly delays, or even prohibits, cross-border or multi-currency transactions. Techniques described herein relate to the intelligent and real-time or near-real-time conversion of currencies, for example, from fiat currency (e.g., the United States Dollar (USD), Euros, Pounds, Pesos, Yen, Rupee, etc.) into another currency, such as a digital asset (e.g., stablecoin, altcoins, dApps, initial coin offerings (ICOs), tokens, etc.) or vice versa, to facilitate cross-border (e.g., across borders in different jurisdictions, territories, countries, financial institutions, etc.) or multi-currency transactions. In some examples, cross-border or multi-currency transactions can utilize digital assets, e.g., stablecoin or another digital asset, as an intermediary, such that a first currency can be converted into an intermediary, e.g., stablecoin or another digital asset, before converting the intermediary into another currency for payment. That is, techniques described herein can utilize digital assets to facilitate cross-border or multi-currency transactions that are more efficient than traditional electronic data transfer or remittance mechanisms.

In some examples, techniques described herein can utilize context data associated with transactions to determine whether to convert a first asset into a second asset and if so, an optimal path for such conversion. In some examples, context data can include, but is not limited to, user data, user preferences which can be determined based on the user data, transaction data (e.g., cost of a transaction, item(s) purchased via a transaction, payment data, or the like) associated with a particular transaction or a plurality of transactions, trends or patterns determined from transaction data, geolocation data, time or date data, exchange rates, availability of currencies or blockchains associated with currencies, speed with which the transaction is intended to be settled, risk data associated with individual users, transactions, or currencies, third-party data availed via third-party integrations (e.g., via one or more application programming interfaces (API(s)), software development kits (SDK(s)), or the like. In some examples, such context data can be analyzed using machine-trained models, rules, and/or the like to intelligently determine, and in real-time or near-real-time, whether to perform a conversion and if so, an optimal path for such conversions.

Conventionally and as mentioned above, cross-border or multi-currency transactions are more complex than domestic or single-currency transactions. In existing payment technologies, there are no single party, end-to-end systems to facilitate cross-border payments in a plurality of currency types, e.g., fiat and digital currencies. This is in part because of the involvement of various intermediaries and financial channels, the complexity of payment rails, conversion rates, and the like. Cross-border payments typically involve higher transaction fees and longer processing times than domestic payments because conventional cross-border payments require transmission across multiple intermediaries and financial channels to perform currency conversions and settle payments. In contrast, there have been some experiments with cross border remittances using cryptocurrencies. In such experiments, conversions are made directly between the transacting parties without the need of any intermediaries, the transactions are usually instantaneous and zero- to low-cost. This fares better compared to traditional payment methods that involve banks or clearing houses. Such electronic transactions also bring in record keeping and transparency in dealings. However, in existing techniques, the transactions either remain purely fiat- or purely cryptocurrency-based. Techniques described herein make cross-border payments more integrated or “mixed,” including both fiat and cryptocurrency, more efficient, reduce transaction fees, and nearly eliminate processing times. That is, techniques described herein leverage a network-connected computing platform associated with a service provider to enable real-time or near-real-time conversions and payments, which in some examples, can be with minimal to no transaction fees. In some examples, as described above, such real-time or near-real-time conversions and payments can be “contextual” and/or “intelligent.” Techniques described herein, therefore, offer improvements to existing and conventional payment technologies.

As described above, techniques described herein, can facilitate contextual data transfers that involve the automatic and real-time or near-real-time conversion of assets, such as a digital asset to fiat currency, or vice versa. A “digital asset,” as used herein, can be a natively electronic asset that confers economic, proprietary, or access rights or powers. In some examples, a digital asset, as used herein, can be recorded using cryptographically secured distributed ledger technology or any similar analogue. Digital assets, as used herein, can include virtual currencies, ancillary assets, payment stablecoins, and other securities and commodities. Non-limiting examples of digital assets include fiat currencies, cryptocurrencies, non-fungible tokens (NFTs), alt coins, dApps, tokens, ICOs, stock assets, commodities, or any other asset used as a medium of exchange.

A stablecoin, which can be one type of digital asset as described above, is a unit of cryptocurrency with price stability. Stablecoins can be centralized or decentralized depending on how they are “backed,” or otherwise maintain a relatively stable price. For instance, with centralized stablecoin, such price stability can be obtained by backing or collateralizing cryptocurrency with a reserve asset or external reference, such as a fiat currency. In some examples, stablecoin can be associated with algorithmic mechanisms that control the buying and selling of a reserve asset or external reference to maintain stability in valuation. Some stablecoin, for example with decentralized stablecoin, can be collateralized using cryptocurrency as a reserve. As a result of such backing or collateralization, whether centralized or decentralized, stablecoin is less volatile than more conventional cryptocurrencies. While reference is made herein to conversions between fiat currencies and digital assets, e.g., stablecoins, or vice versa, techniques described herein are applicable to any multi-currency conversions which may or may not involve cross-border transactions.

In an example, data transfers described herein can be “contextual,” leveraging context data associated with parties to data transfers and/or the data transfers themselves to determine whether, how, and/or when to perform conversions between assets. In an example where a data transfer comprises a transaction (e.g., between a customer and merchant, sender and receiver, peer to peer, or the like), techniques described herein can determine context data associated with parties to the transaction and/or the transaction itself. In at least one example, context data can comprise user data, user preferences, which can be determined based on the user data, transaction data (e.g., cost of a transaction, item(s) purchased via a transaction, payment data, or the like) associated with a particular transaction or a plurality of transactions, trends or patterns determined from transaction data, geolocation data, time or date data, exchange rates, availability of currencies or blockchains associated with currencies, speed with which the transaction is intended to be settled, risk data associated with individual users, transactions, or currencies, third-party data availed via third-party integrations (e.g., via one or more application programming interfaces (API(s)), software development kits (SDK(s)), or the like.

In at least one example, techniques described herein can utilize one or more rules or policies for determining how and/or when to perform conversions between assets. That is, in some examples, a service provider can store one or more rules or policies that indicate whether, when, and/or how conversions should be performed. As an example, a rule can indicate that for transactions in a particular fiat currency where a user does not have a balance associated with the particular fiat currency and has a balance associated with stablecoin, the service provider should convert the stablecoin into the particular fiat currency for processing payments associated with such transactions. Or, as another example, a rule can indicate that for transactions in a particular fiat currency where a user does not have a balance associated with the particular fiat currency and has a balance associated with stablecoin, and where a conversion time associated with converting the stablecoin to the particular fiat currency is faster than converting another fiat currency to the particular fiat currency, the service provider should convert the stablecoin into the particular fiat currency for processing payments associated with such transactions. Additional or alternative rules or policies can be imagined. In an example, the service provider can monitor transactions in real-time or near-real-time and can determine context data associated with such transactions. In at least one example, the service provider can compare transactions and associated context data to such stored rules or policies in real-time or near-real-time to determine how and/or when to perform conversions between assets, for example based on expected urgency, costs, choice of intermediaries associated with completion of the transaction.

In some examples, data transfers can be “intelligent,” leveraging models, such as one or more machine-trained models, to determine whether, when, and/or how to perform conversions, in which currencies (digital or fiat, and in what combination of such currencies), which in some examples, can be without input from the parties to the data transfer. As an example, the service provider can monitor transactions in real-time or near-real-time and can determine context data associated with such transactions. In at least one example, the context data can be analyzed using the one or more machine-trained models, or model(s) trained using machine learning mechanisms, to determine which assets to use for payments associated with such transactions. In some examples, the machine-trained model(s) can output an indication of whether to perform a conversion between assets, when to perform the conversion, and/or how to perform the conversion. In this way, techniques described herein can use one or more machine-trained models to intelligently determine whether, when, and/or how to perform conversions in real-time or near-real-time. In some examples, such determinations can indicate an “optimal” asset and/or path for conversion. Such contextual intelligence can optimize cross-border transactions and other data transfers, for example, based on processing times, computing availability, risk, currency availability, user preferences, and/or the like.

In some examples, data transfers can be in “real-time” or “near-real-time,” such that asset conversions can be recorded at a time of a transaction, thereby offering nearly “instant” transfers without the delay of conventional asset conversions. To the extent cryptocurrency or other non-fiat currency can be used for facilitating cross-border or multi-currency transactions, there are limitations with existing technologies. Specifically, with transactions such as point-of-sale transactions or peer-to-peer transactions (e.g., user-to-user, merchant-to-merchant, customer-to-merchant, or the like), there can be a limitation to traditional cryptocurrency transactions in that a significant duration of time is often needed to finalize such transactions as they are added to the global, public ledger (e.g., the blockchain). Further, cryptocurrency transactions can require significant amounts of computing resources for recording transactions on the global, public ledger (e.g., the blockchain). Even in conversions that do not use a blockchain, due to incompatible payment rails and payment systems, conversions between assets can be time and/or cost prohibitive. Techniques described herein leverage a network-connected computing platform associated with a service provider to facilitate real-time or near-real-time conversions that require less time and computing resources that with conventional techniques, as described herein.

In some examples, techniques described herein can utilize at least one of internal ledgers or external exchange systems to facilitate conversions and data transfers to enable “instant” transfers. That is, in some examples, techniques described herein leverage one or more internal ledgers to facilitate conversions between different assets. Recording conversions and/or transfers internally can enable transfers to be made “instantly” and in real-time or near-real-time without having to wait processing times required when using an external blockchain or exchange. In some examples, conversions and/or transfers performed internally can be recorded on external blockchains or in external exchange systems in real-time or near-real-time or at another time, for example, in batches, at a particular cadence, in response to a particular event, or the like. In any event, utilizing internal ledgers to record asset ownership prior to, during, and/or after transactions can enable such conversions and transfers to occur in real-time or near-real-time by alleviating the need to await processing times required in conventional multi-asset transactions and/or cryptocurrency transactions.

Techniques described herein relate to converting assets to facilitate transactions. As described above, stablecoin can be used as an intermediary between fiat currencies and can offer more stability and less friction than other assets such as conventional cryptocurrencies, stocks, or the like. In some examples, a user account may be associated with a stablecoin balance. In an example where the service provider determines to use stablecoin to process payment for a transaction, the service provider can withdraw from the stablecoin balance and the withdrawal can be recorded, for example, in a ledger associated with the stablecoin balance, in an activity feed associated with the payment application, or the like. In some examples, a user account may not be associated with a stablecoin balance and techniques described herein can create stablecoin balances on-the-fly. That is, in an example where stablecoin is determined to be an optimal asset to be used in making a payment, or an optimal asset for use in a conversion to another asset (e.g., as an intermediary), if the user account is not associated with a stablecoin balance, techniques described herein can utilize assets associated with another balance associated with the user account to generate a stablecoin balance on-the-fly. In some examples, such generation can be effectuated using one or more internal ledgers, which can enable the stablecoin balance to be generated in real-time or near-real-time (e.g., “on-the-fly”). The newly created stablecoin balance can then be used for making a payment. In some examples, this can enable users to transact in currencies that they would not otherwise be able to transact.

In some examples, a user account may be associated with a stablecoin balance, but the stablecoin balance may be “hidden” such that it is not visible or otherwise accessible to the user. In some examples, a stablecoin balance can be presented as another asset into which the stablecoin can be converted. That is, in some examples, a user account can be associated with a “synthetic” fiat currency balance that can present as a fiat currency balance, even though the asset associated therewith is stablecoin. As such, a user can transact with other users in the fiat currency of which a user has a synthetic fiat currency balance without the user needing to own any of the fiat currency. Payments or other transactions can utilize the synthetic fiat currency balance (e.g., stablecoin associated therewith) without the user having to deal with conversion rates, times, or the like. That is, while the service provider may perform conversions on the backend, using techniques described herein, a user associated with a user account can see transactions in the fiat currency being performed using their synthetic fiat currency balance. As an example, a user living in Mexico may not be able to store a fiat currency balance of US dollar (USD) but may be able to store a balance of stablecoin (e.g., USD Coin (USDC)) that can be used as USD (e.g., due to the ease and speed of conversions) for transactions with other users, such as in peer-to-peer or point-of-sale transactions. As such, the stablecoin balance can comprise a “synthetic” fiat currency balance of USD. This can enable users to transact in a fiat currency when fiat payment rails are not yet established, compromised, slow, or otherwise unavailable.

In some examples, a stablecoin balance can be linked to a payment instrument, such as a payment card (e.g., virtual, physical, credit, debit, etc.), fob, payment application, biometric identifier (e.g., fingerprint, eyes, face, etc.), or the like. A user can use the payment card at a point-of-sale, for example, in a brick-and-mortar store or an online store of a merchant. The merchant may accept payments in a particular fiat currency that the user may not store (e.g., in a balance). When the user uses the payment instrument, the service provider can draw from the stablecoin balance, convert the stablecoin into the particular fiat currency, and process the transaction. That is, the payment instrument, which may not be backed by the particular fiat currency, can draw from a user's stablecoin balance and settle a transaction in the particular fiat currency. As an example, the service provider can provide a debit card that is not backed by fiat USD in a bank account, but by USDC stablecoin, allowing debit card transactions that draw from a user's USDC balance but settle with a merchant in USD. In some examples, such payment instruments can be linked to multiple balances wherein the context data and/or intelligence described above can be used to determine which balance is an optimal balance to use for processing a particular transaction. This “dynamic” decision making, which can be made at the time of a transaction or after a transaction, can enable a user to use a single payment instrument to access different balances and/or different currencies at a point-of-sale, and which can be settled instantly, or in real-time or near-real-time. Such techniques can offer improvements over existing technologies.

In some examples, cross-border or multi-currency transactions can utilize one or more networks, protocols, or services. As described above, techniques described herein can utilize context data to determine which networks, protocols, or services to use for performing conversions between assets. For instance, in some examples, stablecoin can be used to convert a first asset to a second asset. Alternatively, in some examples, layer-2 networks, such as the Lightning Network, can be used for such conversions. With blockchain, a “layer-1” network is a base network, such as Bitcoin, Ethereum, etc., and its underlying infrastructure. Layer-1 blockchains can validate and finalize transactions without the need for another network. That is, layer-1 blockchains maintain networks within their own ecosystem. Layer-2 solutions are built on top of layer-1 blockchains and use layer-1 blockchains to finalize transactions. An example of a layer-2 solution is the Lightning Network. The Lightning Network enables users to quickly make payments with their Bitcoin off the main blockchain and the final balance can be reported to the main blockchain at a later time. That is, the Lightning Network enables users to send bitcoin transactions to each other on a second layer above the Bitcoin blockchain. Specific details of their transactions are not recorded individually on the Bitcoin blockchain at the time of the transactions. Key details and cryptographic confirmations of the transactions are later recorded on the Bitcoin blockchain. As such, transactions using the Lightning Network are faster than with layer-1 or non-cryptocurrency-based networks, protocols, or services. Further, transactions using the Lightning Network require less computational resources than conventional cryptocurrency transactions.

In some examples, techniques described herein can utilize layer-2 solutions, like the Lightning Network, to facilitate cross-border or multi-currency transactions. In an example, the service provider, such as a payment service, can enable a first user to send a payment, in a first fiat currency, to a second user. The second user can receive the payment in a second fiat currency. In an example, the Lightning Network can be determined to be the optimal conversion path for converting the first fiat currency to the second fiat currency, for example when a transaction is across geographical borders (e.g., US to UK) or involves different currencies (USD to Pounds). As an example, the first user can initiate the transfer from within a payment application. The payment service can cause fiat funds, in the first fiat currency, to be withdrawn from a balance associated with a user account of the first user. The payment service can cause the fiat funds to be converted to a blockchain-based cryptocurrency, such as Bitcoin (for use with the Lightning Network), which can be associated with a wallet of the payment service. In some examples, the payment service can buy the cryptocurrency in the amount of the payment for association with the wallet. In an example, cryptocurrency, in an amount equivalent to the payment, can be transferred to another wallet of the payment service. Such a transfer can occur using the Lightning Network (e.g., for Bitcoin). In some examples, the wallets can be associated with different characteristics. The payment service can then convert the cryptocurrency into the second fiat currency. In some examples, the payment service can sell the cryptocurrency in the amount of the payment for withdrawal from the wallet. As a result of the conversion, the payment service can transfer fiat funds in the second fiat currency to a user account of the second user, for association with a balance in the second fiat currency. As a result, the conversion, and thus payment, can occur instantly and in real-time or near-real-time, and in some examples, across borders. By using the Lightning Network, fewer fees and computing resources can be required. Further, in some examples, parties to the payment need not have cryptocurrency to use the Lightning Network for making such a payment. As such using such a conversion path can provide improvements over existing payment technology.

It should be noted that cross-border transactions require compliance with, among other regulations, anti-money laundering, data privacy, and anti-terrorism financing regulations. Techniques described herein are to be performed in compliance with such regulations and any other regulations relevant to cross-border or other transactions as applicable. Furthermore, techniques described herein are to be performed in compliance with any other regulation relevant to cryptocurrencies, stablecoins, or any other type of digital assets as described or contemplated herein.

The present disclosure provides an understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting examples. The features illustrated or described in connection with one example may be combined with the features of other examples, including as between systems and methods. Such modifications and variations are intended to be included within the scope of the appended claims.

Additional details are described below with reference to several examples. It should be noted that while examples below are described in the context of using stablecoins as an intermediary for facilitating conversions of assets, in additional or alternative examples, additional or alternative digital assets can be used for facilitating such conversions.

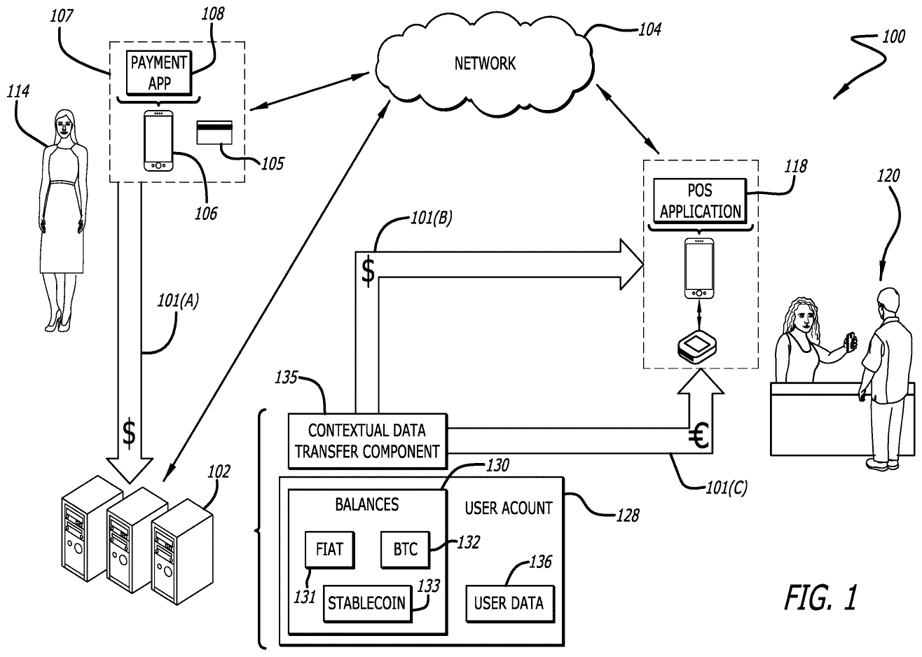

Referring to the figures, FIG. 1 is a network architecture 100 for facilitating a contextual data transfer, in accordance with various embodiments of the present subject matter. In an example, the data transfer can be a transaction 101 involving a user 114, in this example, a customer, and a merchant 120. The transaction 101 can occur over a network 104, such as the Internet. In some examples, the user 114 and the merchant 120 may be in different countries, or otherwise across borders, that utilize different fiat currencies. That is, the transaction 101 may be a cross-border transaction. For illustrative purposes, the transaction 101 is shown in multiple parts. A first part of the transaction 101, depicted as arrow 101(A), is representative of a payment request, received by server(s) 102, that is associated with a payment instrument of the user 114. The payment request is associated with a first currency. A second part of the transaction 101, depicted as arrow 101(B) or arrow 101(C), is representative of a payment transfer, by the server(s) 102, from an account of the user 114 to an account of the merchant 120. In some examples, the payment transfer involves a conversion from the first currency to a second currency, as shown with arrow 101(C). In some examples, stablecoin or another digital asset can be used as an intermediary between the first currency and the second currency, as described below.

In an example, the user 114 utilizes a payment card 105 or payment application 108 executing on a user device 106 (collectively, individual payment instruments 107) to conduct transactions, e.g., cross-border or multi-currency transactions. In an example, the transactions can be conducted using the payment application 108 operated by a service provider through the server(s) 102. In some examples, the service provider can offer payment services, which can include payment processing, payment transfers, and/or the like. The user 114 can utilize their user device 106 to initiate or complete a transaction 101 associated with a merchant 120. In some examples, the transaction 101 can be an in-person transaction, for example, for one or more items (e.g., goods or services) at a brick-and-mortar or other physical point-of-sale of the merchant 120. In some examples, the transaction 101 can be an online or ecommerce transaction, for example, for one or more items to be purchased via an online store or other virtual point-of-sale of the merchant 120. Online or ecommerce transactions can be initiated in a variety of ways and can be commenced, for example, by interacting with an interactive element (e.g., a quick response (QR) code, barcode, hyperlink, deep link, etc.) that directs the user 114 to the merchant's online store or other virtual point-of-sale. The merchant 120 can utilize a point-of-sale (POS) application 118 to process payments via a payment processing service. Additional details associated with a merchant environment are described below.

In at least one example, the service provider can be associated with one or more computing devices, such as server(s) 102. The server(s) 102 can store functional components, such as a contextual data transfer component 135. In some examples, the server(s) 102 can store user accounts associated with users, such as the user account 128 associated with the user 114. In some examples, each user account can be associated with one or more balances 130. These balances 130 can indicate an amount of assets owned by the user 114. As illustrated in FIG. 1, the user 114 can have a balance associated with a particular fiat currency 131, Bitcoin (shown as “BTC”) 132, stablecoin 133, or the like.

As described above, “assets” or “digital assets,” can include fiat currencies, cryptocurrencies, non-fungible tokens (NFTs), alt coins, dApps, tokens, ICOs, stock assets, commodities, etc. In some examples, the assets can be used as a medium of exchange for goods, services, or the like as currency. In some examples, assets associated with the balances can be particular to the payment service (e.g., a stablecoin native to the payment service), a merchant, or a third-party that has been integrated with the payment service and/or to which the payment service has access to. As an example, a stablecoin particular to the service provider or merchant can be backed or collateralized using an external reference such as merchant inventory, transaction data, lending data, payment processing data, or the like. That is, merchants can generate or create stablecoins based on any external metric that can be used to stabilize the value of the stablecoins. In some examples, that can be merchant inventory, transaction data, lending data, payment processing data, or the like. Merchant inventory, transaction data, lending data, payment processing data, or the like can be stored in datastore(s) associated with the server(s) 102.

In FIG. 1, three balances 130 are shown, but a user account can be associated with any number of balances 130, which can be different fiat currencies, cryptocurrencies, digital assets, stock assets, types of accounts (e.g., for saving, spending, shared with one or more users, etc.), or the like. In some examples, the balances can be balances managed by the payment service (e.g., via one or more internal ledgers). In some examples, one or more of the balances can be linked to an external source (e.g., a bank account). In some examples, assets associated with the balances can be associated with multiple entities. For example, some stablecoins can be associated with more than one blockchain. A stablecoin balance, as represented by stablecoin 133 in FIG. 1, can have stablecoins associated with multiple blockchains in the balance. In some examples, multiple balances can represent the same type of asset. For example, for stablecoin associated with multiple blockchains, a user can have a balance of stablecoin for each of the blockchains. In some examples, balances can be called vaults, pockets, sub-accounts, ledgers, wallets, or the like.

In some examples, one or more of the balances can be interest bearing, earn rewards, or otherwise enable users to increase the value of their assets. In cryptocurrency, this can be referred to as “yield farming,” whereas for stocks, this can be referred to as “investing,” and for fiat currency, this can be referred to as “saving.” In some examples, the payment service can have mechanisms to enable users to increase the value of their assets. In other examples, the payment service can integrate with one or more third parties to enable users to increase the value of their assets.

In an example, the payment application 108 can be configured to allow the user 114 to interchange assets freely and/or deposit further types of assets in the user account 130 without limitation. In some examples, the user 114 can receive assets (e.g., deposits) from linked bank accounts, direct deposits (e.g., payroll paycheck, tax refunds, etc.), peer-to-peer payments, sales, or the like. In some examples, deposits can be allocated among one or more of the balances. In some examples, such deposits can be converted into assets depending on which of the balances they are deposited. That is, in some examples, the server(s) 102 can provide “on ramps” for exchanging fiat currency for cryptocurrency and/or stablecoin that can be used in transactions as described herein. The user 114 can move assets into and out of individual balances. In addition to receiving assets, the user 114 can withdraw assets from the individual balances, for example, via transfers to linked bank accounts, recurring payments, peer-to-peer payments, purchases of new assets, cash withdrawals, or the like. That is, in some examples, the server(s) 102 can provide “off ramps” for exchanging cryptocurrency and/or stablecoin for fiat currency. In some examples, balances can be represented with a ledger, which can represent deposits, withdrawals, transfers, or the like.

In some examples, as described herein assets associated with the balances 130 can be used for making “cardless” (e.g., card-not-present) or digital payments. That is, such balances can be accessible via payment mechanisms that do not utilize a payment card. In at least one example, one or more of the balances can be linked to a payment instrument, such as the payment instrument 105. That is, the payment instrument, which can be a virtual or physical credit card, virtual or physical debit card, fob, mobile application, a biometric identifier, or the like can be used to access the balances 130. In some examples, when a payment instrument is used at a point-of-sale, the server(s) 102 can determine which balance to withdraw assets from. In some examples, such a determination can be based on context data and/or intelligence, as described below. In some examples, the user 114 can designate which balance to withdraw assets from, for example, via an interaction with a UI presented via the payment application 108.

In some examples, the user 114 can obtain physical cash in a particular fiat currency by withdrawing funds from a balance. In some examples, if the user 114 has a balance in the particular fiat currency, the user 114 can withdraw funds from said balance. In other examples, for example, when the user 114 does not have a balance in the particular fiat currency, the user 114 can receive or store stablecoin or another cryptocurrency in a balance, as described above, and can “cash out” the balance, or a portion thereof, in the particular fiat currency. In some examples, access to such assets can be via an automated teller machine (ATM), a merchant, such as the merchant 120, another user, or the like. For example, in at least one example, the server(s) 102 can generate a redemption code, such as a set of numbers, a QR code, a barcode, or the like to be presented at the ATM, the merchant, the other user, or the like. In some examples, a user device of the other user can read and/or receive an input of the set of numbers, QR code, barcode, or the like to confirm an identity of the recipient and provide an indication of the transaction to the server(s) 102. In response to receiving the indication of the transaction, the server(s) 102 can authorize and/or facilitate the withdrawal and enable the user 114 to receive physical cash from the ATM, merchant, other user, or the like. The transfer of assets can be documented in one or more internal ledgers, as described herein. In some examples, this can enable users to make cross-border or cross-currency transactions in cryptocurrency, stablecoin, or another asset and to enable the recipient to withdraw physical cash in a fiat currency that they can use to transact. The ability to access funds in the particular fiat currency gives the user 114 access to an asset that they may not have otherwise had access to, for example, due to lack of payment rails or payment systems.

With respect to the transaction 101, the user 114 can provide one of the payment instruments 107 as payment for the transaction 101. In some examples, the payment instrument may be the payment application 108 or the payment card 105. The server(s) 102 can receive payment data associated with the payment instrument as shown by the arrow 101(A) representing a first part of the transaction 101. In some examples, the payment data can be received from the POS application 118, server(s) associated with the POS application 118, the payment application 108, and/or the like. In some examples, the payment data may not be received but instead retrieved or otherwise accessed from a datastore associated with the server(s) 102.

In some examples, the payment data can be received with transaction data. Transaction data can indicate item(s) being purchased in the transaction 101, parties involved in the transaction 101 (e.g., the user 114 and the merchant 120), a total cost of the transaction 101, an indicated currency for payment of the transaction 101, a date of the transaction 101, a time of the transaction 101, a geolocation associated with the transaction 101, payment data received in association with the transaction 101, and so on. In some examples, such transaction data can be stored by the server(s) 102 for use as context data and/or training data for training models, as described below.

As described above, in some examples, the server(s) 102, via a contextual data transfer component 135, can generate and/or determine context data and utilize context data to dynamically determine which asset(s) to use for payment associated with the transaction. That is, in some examples, determinations of which asset to use for a transaction, whether to perform a conversion, when to perform a conversion, how to perform the conversion, or the like can be contextual determinations. Take as an example, in transaction 101, the user 114 wants to remit funds to the merchant 120. As stated above, the user 114 and the merchant 120 may be in different countries and/or have a preference to transact (e.g., send/receive funds) in different currencies. As described below, the contextual data transfer component 135 can monitor contextual data—such as the currency preferences and/or geographical boundaries—to determine, in an example, the fastest or most secure payment rail, best exchange rate, or otherwise optimal channel for facilitating the transfer of funds between the user 114 and the merchant 120. In some examples, the contextual data transfer component 135 can identify one or more options for facilitating the transfer of funds and, in some examples, one or more of the options can utilize one or more intermediate conversions (e.g., first fiat currency to stablecoin to second fiat currency). That is, the contextual data transfer component 135 can make a determination with respect to whether to complete the payment transfer (e.g., the second part of the transaction 101) via a first path, represented by the arrow 101(B), or a second path, represented by the arrow 101(C). While two parts of the transaction 101 are shown and two paths are represented, in additional or alternative examples, the transaction 101 can have any number of parts and any number of paths can be considered. Additional details are described below.

The contextual data transfer component 135 can leverage context data associated with parties to the transaction (e.g., the user 114, the merchant 120, etc.), the transaction 101, or the like to determine whether to perform a conversion, when to perform a conversion, how to perform the conversion, or the like. As described above, context data can include, but is not limited to, user data, user preferences which can be determined based on the user data, transaction data (e.g., cost of a transaction, item(s) purchased via a transaction, payment data, or the like) associated with a particular transaction or a plurality of transactions, trends or patterns determined from transaction data, geolocation data, time or date data, exchange rates, availability of currencies or blockchains associated with currencies, speed with which the transaction is intended to be settled, risk data associated with individual users, transactions, or currencies, third-party data availed via third-party integrations (e.g., via one or more application programming interfaces (API(s)), software development kits (SDK(s)), or the like, and so on.

User data, which can be associated with user accounts, can be data associated with users, such as the user 114 and the merchant 120. As illustrated in FIG. 1, user data 136 is associated with the user account 128 of the user 114. In some examples, datastore(s) associated with the server(s) 102 can store aggregated user data associated with a plurality of users, as described below. In some examples, user data can be stored in user profiles, such as merchant profiles, customer profiles, or the like.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, accepted currency(s), preferred currency(s), transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a balance of the merchant, such as a balance maintained in a ledger by the service provider. In some examples, merchant profiles can be associated with user accounts that store balances. Such balances can be associated with one or more currencies, as described above.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc. In some examples, customer profiles can be associated with user accounts that store balances. Such balances can be associated with one or more currencies, as described above.

User profiles, more generally, can store user data indicative of user interactions with the payment service and/or payment processing service. In some examples, user profiles, which can be associated with user accounts, can indicate balances, such as the balances 130 of the user 114, point-of-sale transactions and associated transaction data, peer-to-peer transactions and associated transaction data, asset inflows, asset outflows, purchased assets, linked payment instruments, linked payment accounts, restrictions, conditions, preferences, or the like.

In some examples, user preferences can be determined from user data. In some examples, such user preferences can indicate behaviors, trends, patterns, or the like of an individual user. In some examples, such preferences can indicate which balance(s) a user prefers to use for making payments. When aggregated user data is analyzed, for example, across a plurality of users of the payment service and/or payment processing service, such preferences can indicate behaviors, trends, patterns, or the like of a plurality of users. In some examples, the plurality of users can be determined to be similar (e.g., using a similarity metric) or otherwise have an existing relationship (e.g., using a social graph or other indicia of a relationship).

As described above, transactions, such as the transaction 101, can be associated with transaction data. Such transaction data can include item(s) being purchased in the transaction 101, parties involved in the transaction 101 (e.g., the user 114 and the merchant 120), a total cost of the transaction 101, an indicated currency for payment of the transaction 101, a date of the transaction 101, a time of the transaction 101, a geolocation associated with the transaction 101, payment data received in association with the transaction 101, and so on. In some examples, transaction data associated with a plurality of transactions can be aggregated and trends or patterns can be determined from transaction data. In some examples, such trends or patterns can be representative of an individual user, a group of users, or all users of the payment service and/or payment processing service, depending on which user(s) the transaction data analyzed is associated.

Geolocation data, which can be determined based on transaction data or other indications of geolocation, can indicate where the parties to the transaction 101 are at the time of the transaction 101. In some examples, time or date data, which can be determined based on transaction data or other indications of time or data, can indicate a time or date of the transaction 101.

In some examples, exchange rates can be determined in real-time or near-real-time using one or more external exchange systems, such as the one or more external exchange systems 136 associated with server(s) 140. In some examples, availability of currencies or blockchains associated with currencies, can indicate which currencies are “available” (e.g., either in a balance of a user account or capable of being availed via a conversion of another asset) and/or which blockchains are “available” (e.g., based on processing times or latency, risk, or the like). In some examples, “availability” of an asset, such as a currency, can be determined based at least in part on the presence (or absence) of payment rails or payment systems. In some examples, “availability” of an asset, such as a currency, can be determined based on an amount owned or accessible to a user. In some examples, a currency may not be available if a balance associated with the currency is below a threshold. In some examples, even if a balance associated with a currency is below a threshold, the currency may be available if additional currency can be obtained via conversion of another asset. In some examples, speeds at which transactions are to be executed are considered as context data.

In some examples, risk data associated with individual users, transactions, or currencies can be determined by the payment service and/or the payment processing service. In some examples, risk can indicate the likelihood of fraud, chargeback, or the like. In some examples, risk can be determined by one or more machine-trained models at a point-of-sale or transaction. In some examples, indications of risk can be stored in association with user accounts such that a quick lookup or search can be performed at a point-of-sale or transaction.

In some examples, third-party data, which can be availed via third-party integrations (e.g., via one or more application programming interfaces (API(s)), software development kits (SDK(s)), can include indications of interactions of users on third-party service providers, such as social networking service providers, gaming service providers, ecommerce service providers, and/or the like.

In at least one example, user data, user preferences which can be determined based on the user data, transaction data (e.g., cost of a transaction, item(s) purchased via a transaction, payment data, or the like) associated with a particular transaction or a plurality of transactions, trends or patterns determined from transaction data, geolocation data, time or date data, exchange rates, availability of currencies or blockchains associated with currencies, speed with which the transaction is intended to be settled, risk data associated with individual users, transactions, or currencies, third-party data availed via third-party integrations (e.g., via one or more application programming interfaces (API(s)), software development kits (SDK(s)), and/or the like can be used to dynamically determine which asset to use for a transaction, whether a conversion is needed for the transaction, when to perform the conversion, how to perform the conversion, and/or the like. In some examples, the server(s) 102, via the contextual data transfer component 135, can analyze context data using one or more rules or policies to determine which asset to use for a transaction, whether a conversion is needed for the transaction, when to perform the conversion, and/or the like. In some examples, the server(s) 102 can analyze context data using one or more machine-trained models to dynamically determine which asset to use for a transaction, whether a conversion is needed for the transaction, when to perform the conversion, how to perform the conversion, and/or the like.

In at least one example, the contextual data transfer component 135 can utilize one or more rules or policies for determining whether, how, and/or when to perform conversions between assets. That is, in some examples, the server(s) 102 can store one or more rules or policies that indicate whether, when, and/or how conversions should be performed. Example rules are provided above. Additional or alternative rules or policies can be imagined. In an example, the contextual data transfer component 135 can monitor transactions in real-time or near-real-time and can determine context data associated with such transactions. In at least one example, the contextual data transfer component 135 can compare transactions and associated context data to such stored rules or policies in real-time or near-real-time to determine whether, how, and/or when to perform conversions between assets.

In some examples, the contextual data transfer component 135 can use one or more models, such as one or more machine-trained models, to determine whether, when, and/or how to perform conversions, which in some examples, can be without input from the parties to the transaction. As an example, the contextual data transfer component 135 can monitor transactions in real-time or near-real-time and can determine context data associated with such transactions. In at least one example, the context data can be analyzed using the one or more machine-trained models, or model(s) trained using machine learning mechanisms, to determine which assets to use for payments associated with such transactions. That is, the context data can be input to the machine-trained model(s), which can output an indication of whether to perform a conversion between assets, when to perform the conversion, and/or how to perform the conversion (e.g., which asset(s) to convert, whether to use internal ledgers or an external exchange system, etc.). In this way, techniques described herein can use one or more machine-trained models to “intelligently” determine when and/or how to perform conversions in real-time or near-real-time. Such contextual intelligence can optimize cross-border transactions and other data transfers, for example, based on processing times, computing availability, risk, currency availability, user preferences, and/or the like.

In some examples, a training component associated with the server(s) 102 can be configured to train models using machine-learning mechanisms. For example, a machine-learning mechanism can analyze training data to train a data model (e.g., a “machine-trained model”) that generates an output, which can be a recommendation, a score, and/or another indication. In some examples, the machine-trained models can be trained on training data including historical transaction data associated with transactions conducted by a plurality of users of the payment service and context data associated with such transactions. In some examples, the machine-trained models generated by the training component can be utilized to determine whether a conversion between currencies or other assets should occur, when such a conversion should occur, how such a conversion should occur, and/or the like. In some examples, as described herein machine-trained models can be used to determine “optimal” currencies and/or conversion paths for payments. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained models can be stored in a datastore associated with the server(s) 102 for use at a time after the machine-trained models have been trained (e.g., at runtime).

With respect to the example transaction 101 illustrated in FIG. 1, in some examples, transaction data associated with the transaction 101 can indicate a fiat currency associated with the transaction. As an example, the user 114 can have a fiat currency balance 131 in USD ($), a BTC balance 132, and a stablecoin balance 133.

In some examples, the merchant 120 may only accept a particular fiat currency (e.g., Euros (€)). The user 114 may not have a balance associated with the particular fiat currency. In conventional techniques, the transaction 101 can fail due to the inability of the merchant 120 to accept other fiat currencies (e.g., USD) and the inability of the user 114 to provide payment in the particular fiat currency (e.g., Euros (€)). While the user 114 and/or the merchant 120 could request a conversion, in conventional technologies, such a conversion can require external parties, thereby jeopardizing the security of the transaction 101, introducing additional data transmissions, and causing a processing lag time, which can make the conversion impractical. Furthermore, in some conventional technologies, such a conversion can need to be completed prior to initiating the transaction and may not be available once a transaction has been initiated. Techniques described herein, however, enable the user 114 to participate in the transaction by converting fiat currency associated with the fiat currency balance 131 to stablecoin, which can be converted into the particular fiat currency accepted by the merchant 120. That is, in the illustrated example, the USD available in the fiat currency balance 131 can be converted to stablecoin, which can be converted to Euros. As such, stablecoin—or another digital asset—can be used as an intermediary to facilitate the transaction 101.

In some examples, the merchant 120 may accept multiple types of currency, such as USD or Euros. In some examples, the contextual data transfer component 135 can utilize context data associated with the transaction 101 and, in some examples, rules, policies, and/or machine-trained models to dynamically determine which currency to use to complete payment for the transaction 101. In some examples, based on a determination by the contextual data transfer component 135 that USD is the optimal currency in which to pay the merchant 120, the server(s) 102 can settle payment for the transaction 101 using USD as shown by the arrow 101(B). In such examples, no conversion may be warranted because the user 114 has a fiat currency balance 131 in USD. In some examples, based on a determination by the contextual data transfer component 135 that Euros are the optimal currency in which to pay the merchant 120, the server(s) 102 can settle payment for the transaction 101 using Euros as shown by the arrow 101(C). In such examples, the contextual data transfer component 135 can facilitate a conversion, for example from USD to Euros, USD to stablecoin to Euros, or the like, to enable the user 114 to use funds from their fiat currency balance 131 in USD for payment to the merchant 120 in Euros. In some examples, the currency determined to be “optimal” may enable a faster payment, have less processing lag, be more secure, be more valuable (e.g., based on exchange rates), provide a benefit to the user 114 and/or merchant 120, or the like.

In at least one example, the server(s) 102 can determine to use the stablecoin balance 133 associated with the user account 130 for at least a portion of the payment for the transaction. In such an example, the contextual data transfer component 135 can convert a portion of the user's 114 stablecoin balance 133 into Euros for payment of the transaction 101, without input or instruction from the user 114. That is, in the example where the user 114 does not have a fiat currency balance in Euros, even though the user 114 does not have a fiat currency balance in Euros, the user 114 can still pay for the transaction 101 using stablecoins in the stablecoin balance 133 (which can be converted to Euros for payment to the merchant 120). Additionally or alternatively, even where the user 114 does have a fiat currency balance in Euros, the user 114 can pay for the transaction 101 using stablecoins in the stablecoin balance 133 based on a determination that doing so is optimal for the user 114, merchant 120, and/or transaction 101.

In some examples, the contextual data transfer component 135 can convert the stablecoin into Euros for payment using one or more internal ledgers. That is, the contextual data transfer component 135 can determine an amount of stablecoin equal to the cost of the transaction 101 (or portion for which stablecoin is being used) in the indicated fiat currency (e.g., Euros) and can withdraw the determined amount from the stablecoin balance 133. In some examples, the amount of stablecoin can be determined based on an exchange rate between the stablecoin and the indicated fiat currency (e.g., Euros), which can be determined based on internal or external exchange rates. In some examples, the contextual data transfer component 135 can deposit the withdrawn stablecoin into a service account balance of the payment service and/or the payment processing service. In such examples, the contextual data transfer component 135 can withdraw the cost of the transaction in the indicated fiat currency from a service account balance and can send the payment, in the indicated fiat currency, to an account of the merchant 120. In some examples, the account of the merchant 120 can be a user account managed by the payment service and/or the payment processing service. In some examples, the account of the merchant can be associated with a third-party service provider, a bank, or the like. In at least one example, the withdrawals and deposits can be recorded on one or more internal ledgers managed by the contextual data transfer component 135, without using an external exchange system. In such examples, and as described below, the payment service and/or payment processing service can own assets, such as stablecoins, that can be fractionalized and allocated to individual user accounts using the internal ledger(s). The use of such internal ledgers can enable the conversions and transfers of assets to be implemented in real-time or near-real-time, thereby offering improvements over existing technologies. That is, the use of such internal ledgers can enable the payment for the transaction 101 to be processed “instantly” without waiting a period of time after the transaction for conversions and other related processing to be complete. In some examples, an external exchange system, which can be associated with server(s) 140, can be used to convert the stablecoin to the indicated fiat currency (e.g., Euros).

In some examples, if the stablecoin balance 133 is less than the cost of the transaction 101 (or portion thereof for which stablecoin is being used), the contextual data transfer component 135 can convert at least a portion of another balance, such as the fiat currency balance 131 or the BTC balance 132, of the user 114 to stablecoin for deposit into the stablecoin currency balance 133, which can be without input or instruction from the user 114. In this way, the contextual data transfer component 135 can fund, and in some examples, generate the stablecoin balance 133 “on-the-fly.” In some examples, the contextual data transfer component 135 can convert at least a portion of a balance into another asset to facilitate a payment for a transaction. In some examples, such conversions can be determined based on contextual data and/or intelligence, as described above. In some examples, such conversions can be facilitated internally, for example, using the internal ledger(s) described above. In some examples, the conversions can be performed using one or more external exchange systems 136, such as those associated with the server(s) 140.

In some examples, the user 114 may not be aware that their user account 130 comprises a stablecoin balance 133. In such examples, and in compliance with regulations as applicable, the stablecoin balance 133 can be presented and/or surfaced to the user 114 when accessing their account through the payment application 108 as a fiat currency balance. For example, the stablecoin balance 133 can be presented and/or surfaced to the user 114 as Euros even though the user 114 does not have a Euro fiat currency balance. In this way, the stablecoin balance 133 in the user account 130 can act as a fiat currency balance and can be considered a “synthetic fiat currency.” The user 114 can use these assets (e.g., stablecoins) to transact with other users, such as the merchant 120, in the fiat currency (e.g., Euros).

In some examples, the payment service and/or payment processing service can have one or more wallets, as described below, with previously funded stablecoin and/or Euros. In these examples, an external cryptocurrency exchange system can be either bypassed or directly owned/operated by the payment service and therefore the transfer of assets can be recorded on one or more internal ledgers as described herein. In some examples, the choice on whether to use internal or external cryptocurrency exchange systems can depend on a variety of factors such as the current exchange rate and/or the amount of assets available in a service account balance. The path of how assets, such as cryptocurrency, can be converted can change moment to moment depending on market conditions. Thus, many examples utilize at least one machine-trained model to determine an optimal path for the currency conversion. The machine-trained model can receive a plurality of context data as inputs for these determinations.

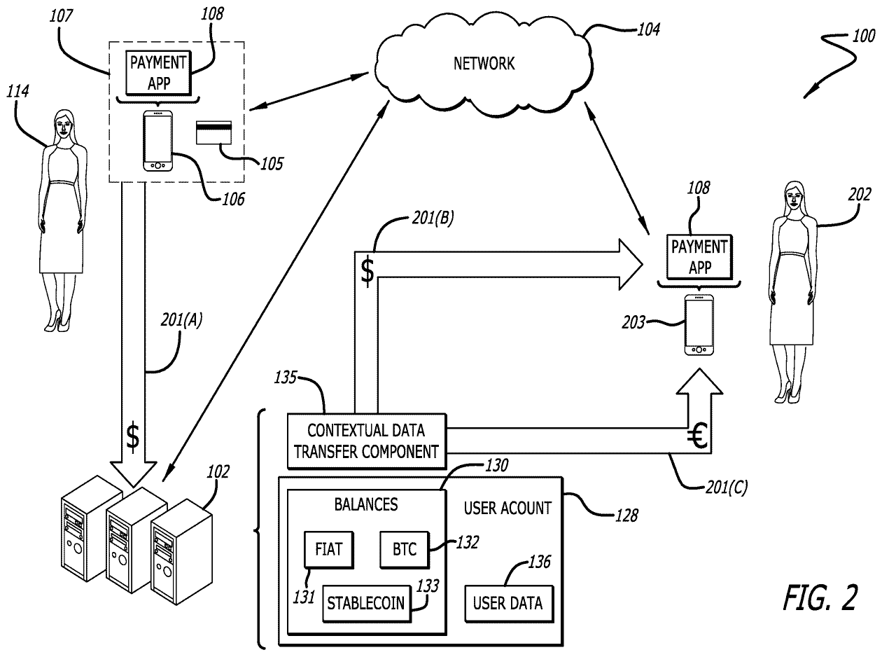

It should be understood that the transaction 101 of FIG. 1 is an example and can be conducted in a number of different ways. While shown as a transaction between a customer and a merchant, in some examples, such a transaction can occur between two “peers,” as illustrated in FIG. 2. In some examples, such peers can be users participating in a digital payment. In some examples, such peers can be two merchants participating in a business-to-business transaction.

FIG. 2 is a network architecture 200 for facilitating a contextual data transfer between a user and another user in accordance with various embodiments of the disclosure. FIG. 2 comprises the same or similar components as FIG. 1. In FIG. 2, however, instead of a merchant, the user 114 is participating in a transaction 201 with another user 202. That is, the user 114 and the user 202 are “peers” and are participating in a peer-to-peer (P2P) transaction. The user 202 can have a user device 203 having an instance of the payment application 108 running thereon. In an example, the payment application 108 can send a request to initiate the transaction 201 to the server(s) 102, as illustrated by the arrow 201(A). In an example, the contextual data transfer component 135 can determine whether, when, and/or how to perform a conversion to facilitate the transaction 201, for example, based on context data associated with the transaction 201, the user 114, and/or the user 202. In some examples, the contextual data transfer component 135 can determine that no conversion is warranted and can facilitate the transaction 201 between the user 114 and the user 202 using a same fiat currency (e.g., USD), as illustrated by the arrow 201(B). In some examples, the contextual data transfer component 135 can determine that a conversion is warranted and can facilitate the transaction 201 between the user 114 and the user 202 by converting a first fiat currency (e.g., USD) to a second fiat currency (e.g., Euros) using one or more exchange mechanisms as described herein, and as illustrated by the arrow 201(C). In some examples, the conversion from the first fiat currency to the second fiat currency can utilize one or more intermediate currencies, such as stablecoin, another cryptocurrency, or the like.

While techniques described above with reference to FIGS. 1 and 2 refer to dynamically determining which balance and associated asset to use for initiating a payment (e.g., a source of a payment), in some examples, the server(s) 102 and/or server(s) 110 can dynamically determine which balance and associated asset is to receive the payment. That is, in some examples, context data can be used to determine which asset a recipient of a payment would like to receive in association with the payment and can deposit the asset into a corresponding balance. In some examples, the server(s) 102 can perform conversions, as described herein, to enable the determined asset to be received and/or deposited into the correct balance.

As mentioned above, conventionally, cross-border or multi-currency transactions are more complex than domestic or single-currency transactions. In existing payment technologies, there are no single party, end-to-end systems to facilitate cross-border payments in a plurality of currency types, e.g., fiat and digital currencies, like the one described above in FIGS. 1 and 2. This is in part because of the involvement of various intermediaries and financial channels, the complexity of payment rails, conversion rates, and the like. Cross-border payments typically involve higher transaction fees and longer processing times than domestic payments because conventional cross-border payments require transmission across multiple intermediaries and financial channels to perform currency conversions and settle payments. In contrast, there have been some experiments with cross border remittance using cryptocurrencies. In such experiments, conversions are made directly between the transacting parties without the need of any intermediaries, the transactions are usually instantaneous and zero- to low-cost. This fares better compared to traditional payment methods that involve banks or clearing houses. Such electronic transactions also bring in record keeping and transparency in dealings. However, as illustrated in FIGS. 1 and 2, the transactions either remain purely fiat- or purely cryptocurrency-based. Techniques described herein make cross-border or multi-currency payments more integrated or “mixed,” including both fiat and cryptocurrency or another digital asset, more efficient, reduce transaction fees, and nearly eliminate processing times.

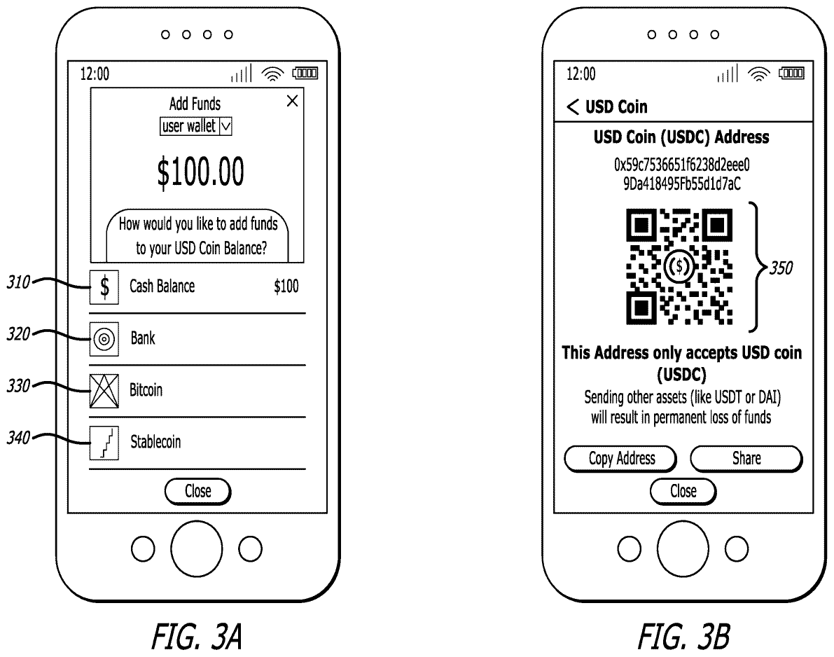

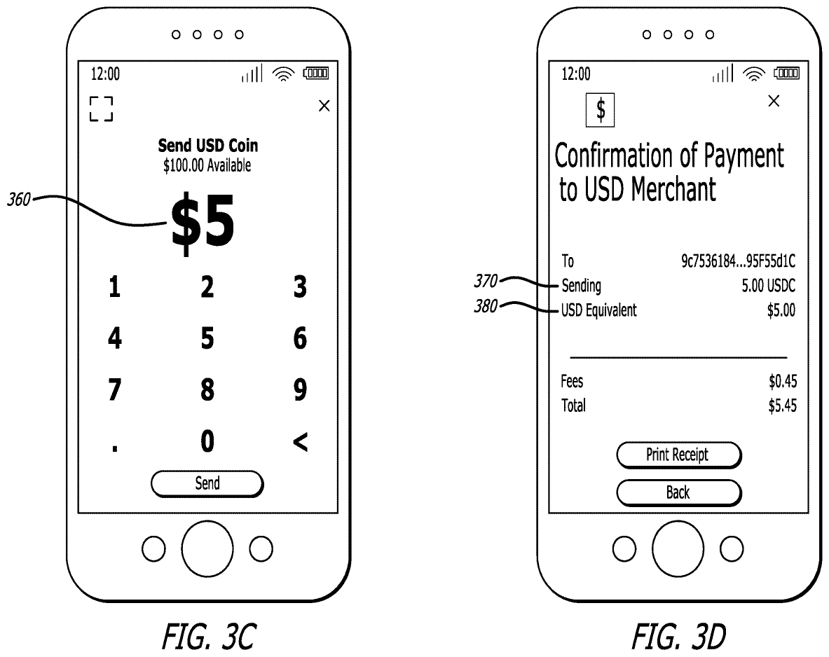

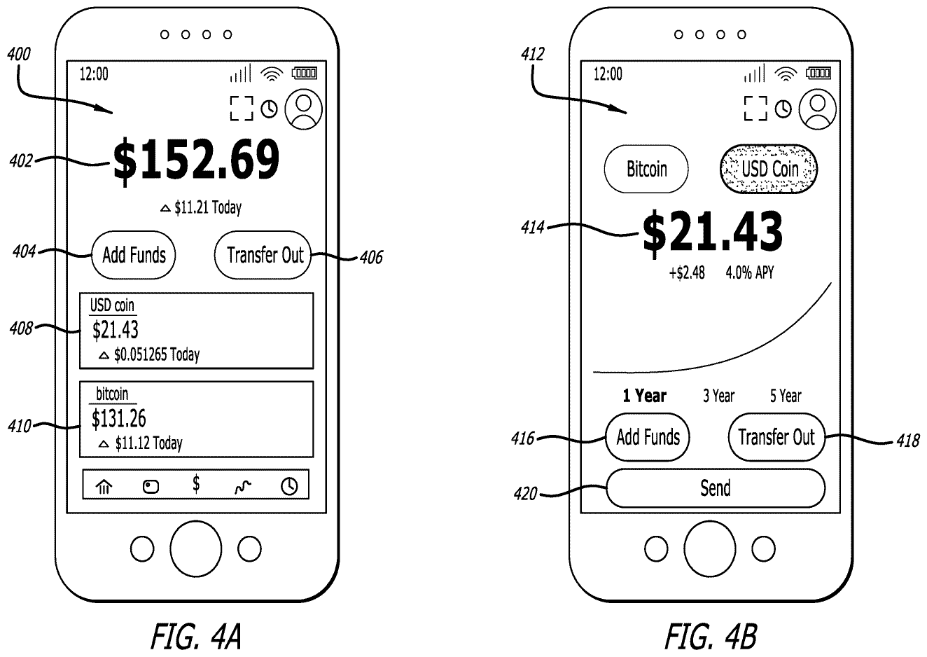

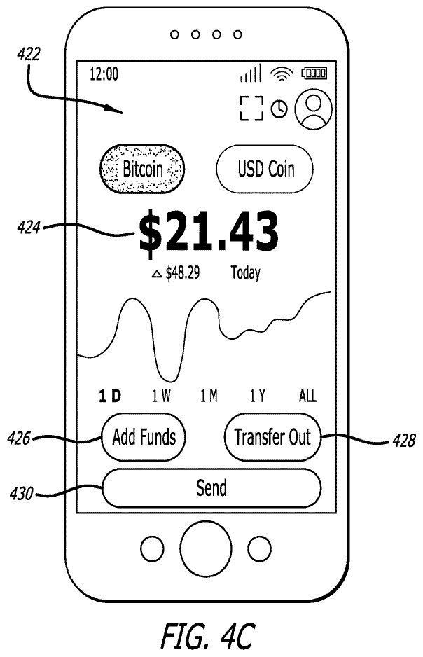

FIGS. 3A-4C illustrate example user interfaces (UI) s. The example UIs can include one or multiple features, components, and/or functionalities of implementations described herein with reference to other figures described herein. FIGS. 3A-4C are examples and additional or alternative data can be presented via UIs via additional or alternative configurations.

FIG. 3A is an example UI of a payment application depicting a selection between various methods of deposit currencies in accordance with various embodiments of the disclosure. As described above, the payment application can be installed and operated from a user device as depicted in FIGS. 3A-3D. The example UI in FIG. 3A shows that a user can select from and utilize different assets to add assets to their user account. Specifically, FIG. 3A shows options for utilizing a stored internal cash balance 310 to add assets which can be used to transfer assets between various balances that can be stored within the user account. Another option shown can be adding assets from a bank 320 which can be done as a balance transfer or other ACH transaction. Such a transfer can be from a “linked” bank account of the user at the bank 320. The bank account can be “linked” to the user account of the user, as managed by the payment service. For users who own cryptocurrency, for example that is stored in an external service and/or wallet, a user can add (or associate) cryptocurrency to their user account such as Bitcoin 330 or a stablecoin 340. As described above, each asset can be associated with a different balance associated with the user account of the user. In some examples, the user can transfer assets into and out of the balances and/or between balances. In some examples, the payment service can use contextual data to determine which balances to use for performing individual transactions, as described above.

FIG. 3B is an example UI of a payment application depicting a payment request received by a user in accordance with various embodiments of the disclosure. The example UI of FIG. 3B shows an example payment request that is requesting to initiate a transaction between two or more users, such as two or more peers in a peer-to-peer transaction, a customer and merchant in a point-of-sale transaction, or the like. The payment request shown can be formatted as an interactive element, such as a QR code 350, that can be easily shared and directs the user to resource location configured to initiate (or complete) a transaction. In some examples, the payment request can be a text message, an email, an in-application message or notification, or the like. The payment request can indicate an amount, a requesting user, currency(s) accepted by the requesting user, or the like. In some examples, the interactive element, such as the QR code 350, can be presented via a POS application or a merchant website.

In some examples, a user can scan, capture, or otherwise interact with the interactive element, such as the QR code 350. In some examples, such an interaction can trigger the dynamic determination of which asset(s) to use for payment, whether to convert asset(s), when to convert asset(s), how to convert asset(s), and/or the like. In some examples, the interactive element can be “dynamic” in that it can be encoded with data for different blockchain networks, different blockchain network layers or protocols (e.g., Lightning Network vs. Bitcoin network), payment services, balances, or the like. In some examples, context data, as described herein can be used to determine which network, network layers or protocols, services, balances, or the like to use to facilitate the payment.

FIG. 3C is an example UI of a payment application depicting a selection of a user payment in response to a payment request in accordance with various embodiments of the disclosure. The example UI of FIG. 3C depicts a UI that allows for the input of an amount to send the merchant in response to a payment request. In FIG. 3C, the amount can be represented by a UI element 360. While the UI of FIG. 3C indicates that the amount can be input by the sending user, the payment application can automatically select the amount for payment based on the payment request, current conversion rate, an amount of a particular currency available, or a combination of these and/or other factors. In some examples, the currency to be used in the payment can be presented via the UI (e.g., if the user has a balance associated therewith). In some examples, the currency to be converted for use in the payment can be presented via the UI (e.g., if the user does not have a balance associated with the currency to be provided as payment to the requesting user). In some examples, a synthetic fiat currency balance can be presented, and a conversion to the fiat currency represented synthetically can be done without user knowledge.

FIG. 3D is an example UI of a payment application depicting a transaction receipt confirming a transaction between users in accordance with various embodiments of the disclosure. As described above, the payment service through the payment application can be able to deposit or otherwise transact with stablecoins or other currencies. In certain embodiments, this process can be done internally and without the knowledge of the user through one or more synthetic fiat currencies. However, in some embodiments, the user can be notified of this transaction and/or exchange. The UI of FIG. 3D shows such a transaction as a user is sending a payment to a merchant that accepts USD currency. Instead of sending the merchant a direct USD payment, the user can instead send 370 a payment in stablecoin (shown in FIG. 3D as 5.00 USD stablecoins or USDC). The stablecoin has a USD equivalent 380 of the amount expected by the merchant.

In conventional technologies, the transaction depicted in FIG. 3D would not be possible within a single application and would require the user to initiate a first transaction with a third-party exchange, receive the USD equivalent, add that amount to their online wallet, and then conduct the transaction with the merchant. However, as stated previously, certain markets may not be able to access USD easily and/or be able to add their USD payouts to a user wallet. Thus, in many embodiments disclosed herein, the user can conduct the transaction utilizing the payment application as a payment processor which can then convert their stored stablecoin to the necessary fiat currency to complete the transaction. However, this can still provide a method for users to utilize a single location and transaction to engage in transactions when the certain fiat currencies are not available to them or to the payment application.

FIG. 4A is an example UI of a payment application depicting a user interface for managing different types of currency from within the payment application in accordance with various embodiments of the disclosure. In FIG. 4A, the UI 400 can include one or more UI elements representative of information and, in some examples, performable operations. In at least one example, the UI 400 can include a UI element 402 representative of a total amount of assets, of a particular asset type (e.g., cryptocurrency) associated with a user account. In some examples, this total amount can comprise a sum of one or more balances, as described above. In some examples, the total amount can be presented in cryptocurrency, fiat currency, or another asset type that can be used to standardize the total amount. In some examples, the UI 400 can include an interactable UI element 404 to enable a user to add cash or other assets to their account. In an example, an interaction with the interactable UI element 404 can cause the UI depicted in FIG. 3A to be presented. In some examples, the UI 400 can include an interactable UI element 406 to enable a user to withdraw cash from their account. In an example, an interaction with the interactable UI element 404 can cause a user to “transfer out” assets via one or more techniques described above. That is, in some examples, an interaction with the interactable UI element 406 can cause a redemption code to be generated for the user to use to obtain physical cash from an ATM, merchant, other user, etc. In some examples, an interaction with the interactable UI element 406 can enable the user to convert a portion of the asset into another asset. For example, the user can convert cryptocurrency or stablecoin into a fiat currency, which can be associated with a different balance.

In at least one example, the UI 400 can include interactable UI elements 408 and 410. In at least one example, an interaction with the interactable element 408 can cause another UI to be presented that enables the user to access additional information with the corresponding balance (e.g., stablecoin), as illustrated in FIG. 4B. The interactable UI element 408 can represent the stablecoin balance 133 described above with reference to FIG. 1. In some examples, the interactable UI element 408 can have an indication of an amount of fiat currency accessible via a conversion of the stablecoin, which can correspond to a synthetic fiat currency balance as described herein. In at least one example, an interaction with the interactable element 410 can cause another UI to be presented that enables the user to access additional information with the corresponding balance (e.g., Bitcoin), as illustrated in FIG. 4C. The interactable UI element 408 can represent the Bitcoin balance 132 described above with reference to FIG. 1. In some examples, each of the interactable UI elements 408, 410 can include information particular to the balance to which the interactable UI element corresponds.

FIG. 4B is an example UI of a payment application depicting a user interface for managing a first cryptocurrency asset from within the payment application in accordance with various embodiments of the disclosure. In FIG. 4B, the UI 412 can include one or more UI elements representative of information and, in some examples, performable operations. In at least one example, the UI 412 can include a UI element 414 representative of a total amount of assets associated with a corresponding balance (e.g., stablecoin). In some examples, the total amount can be presented in cryptocurrency, fiat currency, or another asset type that can be used to standardize the total amount. In some examples, the UI 412 can include an interactable UI element 416 to enable a user to add cash or other assets to the balance. In an example, an interaction with the interactable UI element 416 can cause the UI 3A to be presented. In some examples, the UI 412 can include an interactable UI element 418 to enable a user to withdraw cash from their account. In an example, an interaction with the interactable UI element 418 can cause a user to “transfer out” assets via one or more techniques described above. That is, in some examples, an interaction with the interactable UI element 418 can cause a redemption code to be generated for the user to use to obtain physical cash from an ATM, merchant, other user, etc. In some examples, an interaction with the interactable UI element 418 can enable the user to convert a portion of the asset into another asset. For example, the user can convert cryptocurrency or stablecoin into a fiat currency, which can be associated with a different balance. In some examples, the UI 412 can include an interactable UI element 420 that can enable a user to send assets to another user. That is, an interaction with the interactable UI element 420 can be used to pay or gift an amount of stablecoin to another user.

FIG. 4C is an example UI of a payment application depicting a user interface for managing a second cryptocurrency asset from within the payment application in accordance with various embodiments of the disclosure. In FIG. 4C, the UI 422 can include one or more UI elements representative of information and, in some examples, performable operations. In at least one example, the UI 422 can include a UI element 424 representative of a total amount of assets associated with a corresponding balance (e.g., Bitcoin). In some examples, the total amount can be presented in cryptocurrency, fiat currency, or another asset type that can be used to standardize the total amount. In some examples, the UI 422 can include an interactable UI element 426 to enable a user to add cash or other assets to the balance. In an example, an interaction with the interactable UI element 426 can cause the UI 3A to be presented. In some examples, the UI 422 can include an interactable UI element 428 to enable a user to withdraw cash from their account. In an example, an interaction with the interactable UI element 428 can cause a user to “transfer out” assets via one or more techniques described above. That is, in some examples, an interaction with the interactable UI element 428 can cause a redemption code to be generated for the user to use to obtain physical cash from an ATM, merchant, other user, etc. In some examples, an interaction with the interactable UI element 428 can enable the user to convert a portion of the asset into another asset. For example, the user can convert cryptocurrency or stablecoin into a fiat currency, which can be associated with a different balance. In some examples, the UI 422 can include an interactable UI element 430 that can enable a user to send assets to another user. That is, an interaction with the interactable UI element 430 can be used to pay or gift an amount of Bitcoin to another user.

The UIs 400, 412, 422 can include additional or alternative data and/or UI elements. For example, the UIs can provide educational information relating to what different types of cryptocurrency are, how users can grow, send, receive, spend different types of cryptocurrency, news articles related to the cryptocurrency, recent activity using the cryptocurrency, etc. In some examples, users can configure automatic purchases, sales, transfers, or the like of cryptocurrency assets associated with each balance. In some examples, users can opt into interest or rewards associated with the balances. That is, FIGS. 4A-4C are provided as examples and should not be construed as limiting. Further, in some examples, a user can interact with the payment application to show similar UIs representative of other balances as described herein.

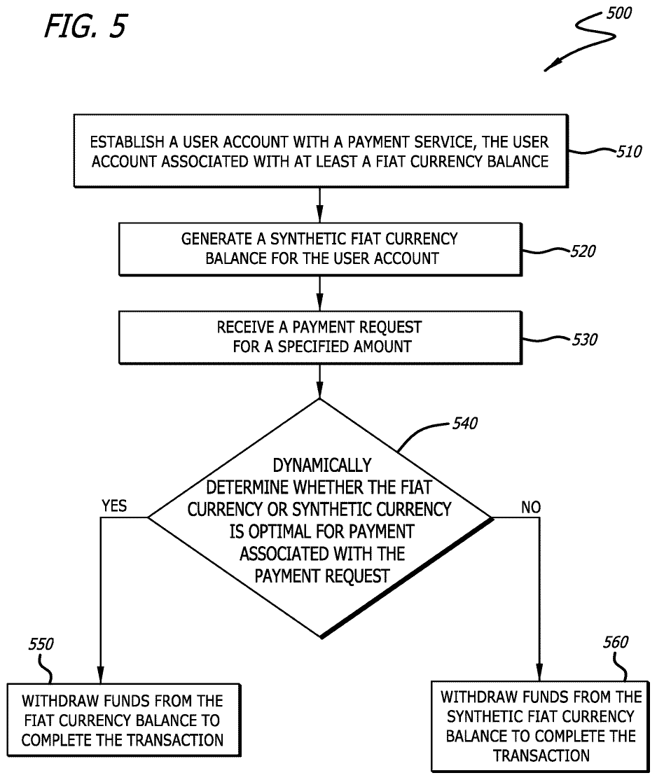

FIGS. 5-7 illustrate processes 500, 600, and 700, respectively, in accordance with various embodiments of the disclosure. The processes described herein are illustrated as a collection of blocks in flowcharts, each representing a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 5 is an example method 500 for processing a transaction in accordance with various embodiments of the disclosure.

At operation 510, a user account can be established with a payment service. The user account can be associated with at least a fiat currency balance. In at least one example, the user account can be associated with or otherwise control one or more other balances and can enable a user to access services provided by the payment service. As an example, the user account can comprise one or more fiat currency balances, one or more stock balances, one or more cryptocurrency balances, and/or the like. Additional details associated with balances are described above. As described below, the user account can enable a user to manage money, buy, sell, and/or gift assets, such as stocks or cryptocurrency, and/or perform other operations as described herein. The payment service can establish user accounts in a variety of ways but can operate one or more payment applications that users can utilize on their user devices to access user account information, balances, and/or services as described herein. Once a user account is established, the method 500 can omit this operation (510).

At operation 520, a determination can be made to generate a synthetic fiat currency balance for the user account. In some examples, the server(s) associated with the payment service can make such a determination. In some examples, a determination can be based on a variety of context data, as described in more detail above. However, in one example, the context data can be historical purchases from the user. If a user is known to conduct transactions in a fiat currency not currently within their user account, and that has a stablecoin associated with the fiat currency, the need for a synthetic fiat currency balance can be determined. In some examples, context data can indicate that a stablecoin is an optimal currency for a particular transaction and the need for a synthetic fiat currency balance can be determined. In some examples, the need can be determined at a time of a transaction wherein the user does not have a balance, or a sufficient balance, in a fiat currency indicated for payment. That is, in some examples, the need can be determined at a time of a transaction (e.g., on-the-fly) and a synthetic fiat currency balance can be generated on-the-fly.

In some examples, server(s) associated with the payment service can convert a portion of an asset associated with the user account, which can be deposited and/or stored in a balance, for example, to stablecoin, which can be stored in a synthetic fiat currency balance. As described above, in some examples, such a conversion can be facilitated via one or more internal ledgers. In some examples, such a conversion can be facilitated via an external exchange with resulting assets being deposited into the balance representative of the synthetic fiat currency balance. In some examples, the stablecoin can be transferred from an external exchange system to the payment service.

At operation 530, a payment request for a specified amount can be received. In at least one example, server(s) associated with the payment service can receive a payment request associated with the user. FIGS. 1 and 2 illustrate example transactions. In some examples, the payment request can be associated with a transaction, which can be associated with transaction data. In some examples, the transaction data can indicate a specified amount and a currency in which a payment is to be paid. In some examples, the transaction can be a point-of-sale transaction, wherein the user is a customer of a merchant. In some examples, the payment request can be presented via a payment application executing on a user device of the user. In some examples, the payment request can be presented via a POS application executing on a user device of the merchant. In some examples, the transaction can be a peer-to-peer transaction between two users. In some examples, the payment request can be a request to receive payment. In some examples, the payment request can be a request to send payment.

At operation 545, the process 500 can dynamically determine whether the fiat currency or synthetic fiat currency is optimal for payment associated with the payment request. That is, server(s) associated with the payment service can determine an optimal currency for payment of the payment request. In some examples, as described above, the server(s) can determine context data associated with the user, the transaction, and/or the like. The server(s) can use the context data to determine an optional currency for payment of the payment request. In some examples, the server(s) can use rules or policies. For example, a rule or policy can indicate that if a user does not have a fiat currency balance in the same fiat currency as indicated with the payment request, to use the synthetic fiat currency balance. In some examples, the server(s) can use machine-trained model(s), which can take into account user preferences, available balances, payment services, blockchains, conversion rates, and/or the like in determining an optimal currency to use for payment.

In an example where the server(s) determine that the fiat currency in the user account is the optimal currency for payment, the method 500 can withdraw assets from the fiat currency balance to complete the transaction, as illustrated at operation 550. In some examples, the assets can be transferred directly to an account of a user requesting payment (e.g., a merchant, another user, or the like). In some examples, the assets can be transferred to a service account of the payment service and held until the assets are transferred to the account of the user requesting payment. In some examples, such a transfer can be recorded in one or more ledgers of the payment service.

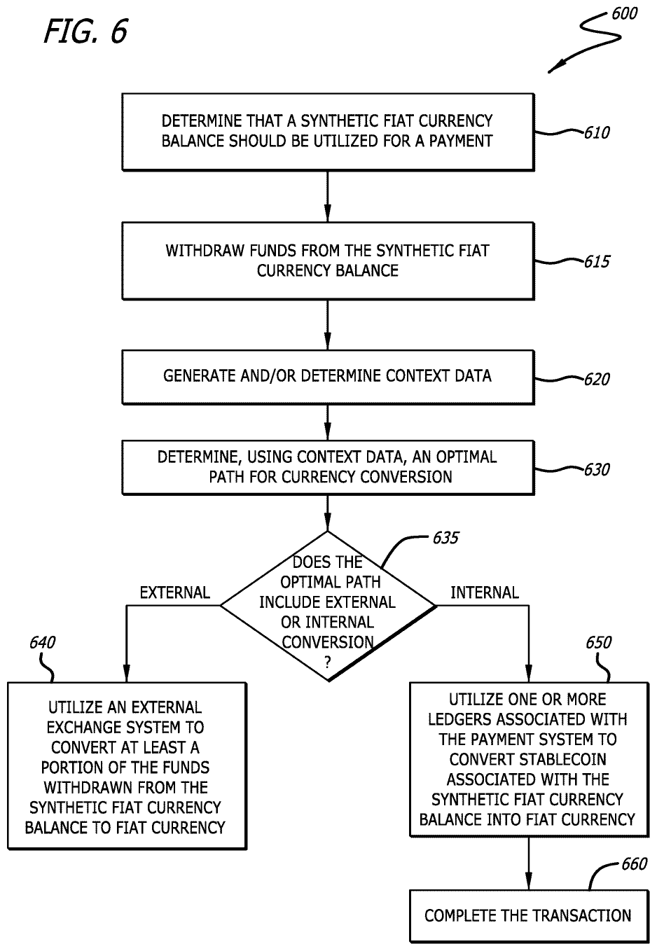

In an example where the server(s) determine that the synthetic fiat currency is the optimal currency for payment, the method 500 can withdraw assets (e.g., stablecoins) from the synthetic fiat currency balance to complete the transaction, as illustrated at block 560. In some examples, the assets can be transferred directly to an account of a user requesting payment (e.g., a merchant, another user, or the like). In some examples, the assets can be transferred to a service account of the payment service and held until the assets are transferred to the account of the user requesting payment. In some examples, such a transfer can be recorded in one or more ledgers of the payment service. In some examples, the assets withdrawn from the synthetic fiat currency balance can be converted into a fiat currency indicated in the payment request prior to being transferred to the account of the user requesting payment and/or the service account of the payment service. In some examples, the payment service can determine an optimal conversion path and convert at least some of the synthetic fiat currency balance into the fiat currency needed to complete the transaction. This process is described in more detail within the discussion of FIG. 6.

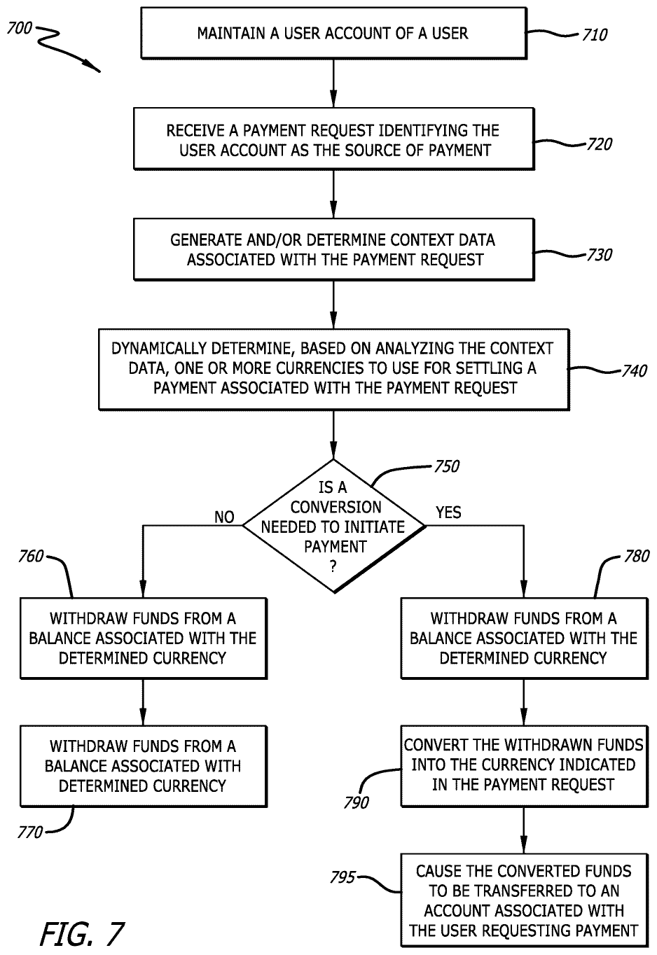

While FIG. 5 illustrates two possible “optimal” paths for completing payment, additional or alternative paths are within the scope of this disclosure. That is, in some examples, at block 545, the server(s) can determine any “optimal” path, which can include processing a payment using assets associated with any balance associated with the user account or any asset that can be obtained using assets associated with any balance associated with the user account. That is, the determination of an optimal path for completing a payment is not limited to a binary decision as illustrated in FIG. 5. Further in some examples, transactions can be “mixed,” including both fiat currency and digital assets, such as stablecoin or another digital asset. In some examples, the synthetic fiat currency balance can be generated as an intermediary between a first currency associated with the sender of the payment request and a second currency associated a recipient of the payment request. Additional details are provided below in FIG. 7.

FIG. 6 is an example method 600 for determining an optimal path for cryptocurrency conversion utilizing context data in accordance with various embodiments of the disclosure is shown. The method 600 can include one or multiple features, components, and/or functionalities of implementations described herein with reference to FIGS. 1-5 and 7-13.

At operation 610, a determination that a synthetic fiat currency balance should be utilized for a payment can be made. As described above in the discussion of FIG. 5, server(s) associated with a payment service can determine that a payment is to be completed utilizing at least a portion of a synthetic fiat currency balance associated with a user account operated by the payment service. As described above, in at least one example, the synthetic fiat currency balance can comprise a stablecoin balance. In at least one example, the server(s) can withdraw assets from the synthetic fiat currency balance, as illustrated at operation 615. In at least one example, the assets can be transferred to a service account of the payment service until the assets are converted into the fiat currency.

In some examples, a conversion from stablecoin, associated with the synthetic fiat balance, to fiat currency can be necessary or otherwise determined to be optimal. The optimal path to perform this conversion can be determined. This determination can begin by generating and/or determining context data, as illustrated at operation 620. That is, server(s) associated with the payment service can generate and/or determine context data associated with a payment request associated with the payment, parties associated with the payment request, and/or the like. Context data is described in more detail above.

At operation 630, the context data can be used to determine an optimal path for the currency conversion. That is, server(s) associated with the payment service can analyze the context data to determine an optimal path for converting stablecoin to a fiat currency for completing the payment. As discussed above within the discussion of FIGS. 1 and 2, the optimal path for the conversion can utilize internal ledgers and/or external exchange systems.

At operation 635, the method 600 can determine if the optimal path includes external or internal currency conversion. In many examples, server(s) associated with the payment service can determine the optimal path using one or more machine-trained models. These machine-trained model(s) can receive the context data as input and generate a determination of the optimal pathway for conversion as output.

When it is determined that the optimal path includes an external currency conversion, the method 600 can utilize an external exchange system to convert at least a portion of the stablecoin associated with the synthetic fiat currency balance to fiat currency, as illustrated at operation 640. In some examples, server(s) associated with the payment service can determine that an internal conversion path is an optimal path for converting the stablecoin associated with the synthetic fiat currency balance to fiat currency. In such examples, as illustrated at operation 650, the method 600 can utilize one or more ledgers associated with the payment system to convert stablecoin associated with the synthetic fiat currency balance into fiat currency.

Upon internal and/or external conversion, the transaction can be completed, as illustrated at operation 660. In some examples, the user can then receive a record of the transaction, such as a receipt as depicted in FIG. 3D, to indicate that the transaction has been completed. In some examples, such a record can be provided via text message, email, an in-application notification, an update to an activity feed or other UI presented via a payment application, or the like.

As described above, in some examples, the user can have a stablecoin balance that shows a withdrawal if they had previously deposited a stablecoin suitable for conversion for the transaction. This withdrawal can be shown in association with a synthetic fiat currency balance. In some examples, the user may not have a stablecoin balance showing in their account and can be shown as a fiat currency balance. In such an example, the payment service can have previously generated at least a portion of their fiat currency balance into a synthetic fiat currency balance. As such, the payment application can be configured not to show the user the synthetic fiat currency balance or that a conversion was done in their transaction. Records can be generated for presentation to a user that do not indicate a conversion occurred, while an internal record can be generated that indicates the conversion done and some or all other steps within the transaction process. In this way, the user can be provided a simpler and streamlined transaction process.

In some examples, prior to or in association with a conversion between assets, the server(s) may prompt a user to provide one or more credentials to authenticate themselves. This can be helpful for verifying or validating identities.

FIG. 7 is an example method 700 for facilitating transactions through a payment service utilizing available balances in accordance with various embodiments of the disclosure is shown. The method 700 can include one or multiple features, components, and/or functionalities of implementations described herein with reference to FIGS. 1-6 and 8-13.

At operation 710, a user account of a user can be maintained. The user account can be held or otherwise operated by a payment service. The user account can enable a user to access services of the payment service, as described above. In at least one example, the user account can be associated with one or more balances, which can be associated with one or more currencies or other assets. In at least one example, the user account can be associated with a fiat currency balance and a stablecoin balance. In some examples, the stablecoin balance can be referred to herein as a “synthetic” fiat currency balance.

At operation 720, a payment request can be received identifying the user account as a source of payment. In an example, server(s) associated with the payment service can receive a payment request. The payment request can be associated with a transaction between the user and another user. In some examples, the payment request can come in the form of an invoice or point-of-sale transaction from a merchant or from another user with access to the payment service, for example in a peer-to-peer transaction. In some examples, the payment request can be associated with a request to pay another user. In some examples, the payment request can be associated with transaction data. In some examples, the transaction data can indicate an amount of the transaction and, in some examples, an indicated currency in which payment is to be made.

At operation 730, context data associated with the payment request can be generated and/or determined. In an example, server(s) associated with the payment service can generate and/or determine context data associated with the payment request. Context data is described above. In at least one example, at operation 740, the context data can be analyzed to dynamically determine one or more currencies to use for settling a payment associated with the payment request. As discussed above, server(s) associated with the payment service can analyze the context data, for example, using rules, policies, and/or machine-trained models to dynamically determine one or more currencies to use for payment. In some examples, the server(s) can utilize the context data to determine whether to use a fiat currency balance or a stablecoin balance (e.g., synthetic fiat currency balance), as illustrated in FIG. 5. In some examples, the server(s) can determine to use any currency, which can include processing a payment using currencies associated with any balance associated with the user account or any currency that can be obtained using currencies associated with any balance associated with the user account.

At operation 750, it can be determined whether a conversion is needed to initiate a payment. In an example where server(s) associated with the payment service determine to use a currency for payment that is the same currency as indicated in the payment request (e.g., that a conversion is not needed), the server(s) can withdraw assets from a balance associated with the currency determined to be optimal for the payment, as illustrated at operation 760, and transfer the assets to an account associated with the user requesting payment, as illustrated at operation 770. In some examples, the amount of the assets withdrawn can correspond to the amount of the payment request. In some examples, the amount can be more or less than the amount of the payment request, for example, based on transaction fees, exchange rates, or the like. In an example, where the server(s) determine to use a fiat currency that is associated with a fiat currency balance of the user account, the server(s) can withdraw the assets from the fiat currency balance of the user account and transfer the assets to another user account associated with the user requesting payment. In some examples, the assets can be transferred first to a service account of the payment service prior to transferring the assets to the user account of the requesting user. The fiat currency can originate from the fiat currency balance associated with the user account. The amount of the fiat currency sent can correspond to the amount of the transaction as requested in the payment request. In some examples, the amount can be more or less than originally withdrawn based on transaction fees, exchange rates, or the like. In some examples, such a transfer can be recorded in one or more ledgers associated with the payment service.

In an example where server(s) associated with the payment service determine to use a currency that is different from the currency as indicated in the payment request (e.g., that a conversion is needed), at operation 780, assets from a balance associated with the currency determined to be optimal for the payment can be withdrawn, converted into the currency indicated in the payment request, as illustrated at operation 790, and transferred to an account associated with the user requesting payment, as illustrated at operation 795. In some examples, the user may not have a balance associated with the currency indicated in the payment request and as such, the server(s) can determine to use another currency, associated with a balance associated with the user account, that can be converted into the currency indicated in the payment request. As an example, where the server(s) determine to use stablecoin that is associated with a stablecoin balance (e.g., or a “synthetic” fiat currency balance) associated with the user account, the server(s) can convert the stablecoin into a fiat currency associated with the payment request. In additional or alternative examples, the user may have a balance associated with the currency indicated in the payment request but the server(s) may determine an alternative currency is optimal for making the payment. In such an example, the server(s) can convert a portion of a balance corresponding to the determined currency into the currency as indicated in the payment request.

In at least one example, to effectuate a conversion between a first currency and a second currency, the server(s) can determine an amount of the first currency that corresponds to the amount of the second currency indicated in the payment request. In some examples, the server(s) can use one or more exchange rates to determine the amount of the first currency. The exchange rate(s) can be determined from external exchange systems or internal exchange rates. The server(s) can convert a portion of a balance associated with the first currency, corresponding to the determined amount of first currency, into the second currency. In some examples, the server(s) can use one or more internal ledgers to effectuate the conversion. That is, the server(s) can decrease the balance associated with the first currency by the determined amount to effectuate a withdrawal of the assets. In some examples, the amount of the assets withdrawn can correspond to the amount of the payment request. In some examples, the amount can be more or less than the amount of the payment request, for example, based on transaction fees, exchange rates, or the like. The withdrawn first currency can be added to a balance, associated with the first currency, associated with a service account of the payment service. The amount of second currency as indicated in the payment request can be withdrawn from another balance, associated with the second currency, associated with the service account and transferred to a user account of the requesting user in the second currency requested with the payment request. The amount of the second currency transferred can correspond to the amount of the payment request. In some examples, the amount can be more or less than originally withdrawn based on transaction fees, exchange rates, or the like. In some examples, the transfers described above can be recorded in one or more ledgers associated with the payment service. In some examples, an external exchange system can be used to perform a conversion between currencies. In some examples, machine-trained model(s) can be used to determine which conversion path is an optimal path for implementing the conversion, as described above with reference to FIG. 6.

In an example where a payment request is associated with a fiat currency and the currency determined to be optimal for the payment is stablecoin or stablecoin is determined to be an optimal intermediary for facilitating a conversion, to effectuate a conversion between stablecoin and fiat currency, the server(s) can determine an amount of stablecoin that corresponds to the amount of the transaction, in the fiat currency indicated in the payment request. In some examples, the server(s) can use one or more exchange rates to determine the amount of stablecoin. The exchange rate(s) can be determined from external exchange systems or internal exchange rates. The server(s) can convert a portion of the stablecoin balance, corresponding to the determined amount of stablecoin, into the indicated fiat currency. In some examples, the server(s) can use one or more internal ledgers to effectuate the conversion. That is, the server(s) can decrease the stablecoin balance of the user by the determined amount to effectuate a withdrawal of the assets from the stablecoin balance. An equivalent amount of stablecoin can be added to a stablecoin balance associated with a service account of the payment service. The amount of fiat currency as indicated in the payment request can be withdrawn from another balance, associated with the fiat currency, associated with the service account and transferred to a user account of the requesting user in the fiat currency requested with the payment request. In some examples, an external exchange system can be used to facilitate the conversion, as described above. That is, stablecoin or another digital asset can be an intermediary to facilitate the transaction.

In some examples, as described above, the server(s) can utilize context data to determine whether, when, and/or how to convert between assets associated with a transaction. In some examples, context data can be used to determine whether to use stablecoin, as described above, or another asset, service, network, protocol, or the like. In at least one example, the server(s) can determine to use the Lightning Network to facilitate cross-border or multi-currency transactions. In some examples, the server(s) can determine the Lightning Network is the optimal path for handling conversions based on speed, fees, availability of a Bitcoin or stablecoin balance (or not), or the like.

In an example, the server(s) can enable a first user to send a payment, in a first fiat currency, to a second user. The second user can receive the payment in a second fiat currency. In an example, the first user can initiate the transfer from within a payment application. The server(s) can cause fiat funds, in the first fiat currency, to be withdrawn from a balance associated with a user account of the first user. The server(s) can cause the fiat funds to be converted to Bitcoin, which can be associated with a Bitcoin wallet of the payment service. In some examples, the server(s) can buy the Bitcoin in the amount of the payment for association with the Bitcoin wallet. In some examples, the server(s) can use one or more ledgers. In an example, Bitcoin, in an amount equivalent to the payment, can be transferred to another Bitcoin wallet of the payment service. Such a transfer can occur using the Lightning Network. The server(s) can then convert the Bitcoin into the second fiat currency. In some examples, the server(s) can sell the Bitcoin in the amount of the payment for withdrawal from the Bitcoin wallet. In some examples, the payment service can use one or more ledgers. As a result of the conversion, the server(s) can transfer fiat funds in the second fiat currency to a user account of the second user, for association with a balance in the second fiat currency. As a result, the conversion, and thus payment, can occur instantly and in real-time or near-real-time. By using the Lightning Network, fewer fees and computing resources can be required. Further, in some examples, parties to the payment need not have Bitcoin or another cryptocurrency to use the Lightning Network for making such a payment. As such using such a conversion path can provide improvements over existing payment technology.

While FIG. 7 illustrates a binary decision at step 750, in some examples, payments can be made using multiple currencies. In some examples, a portion of a payment can be made using fiat currency and a digital asset such as stablecoin. In such examples, the decision at step 750 and subsequent steps can be performed for a portion of a payment.

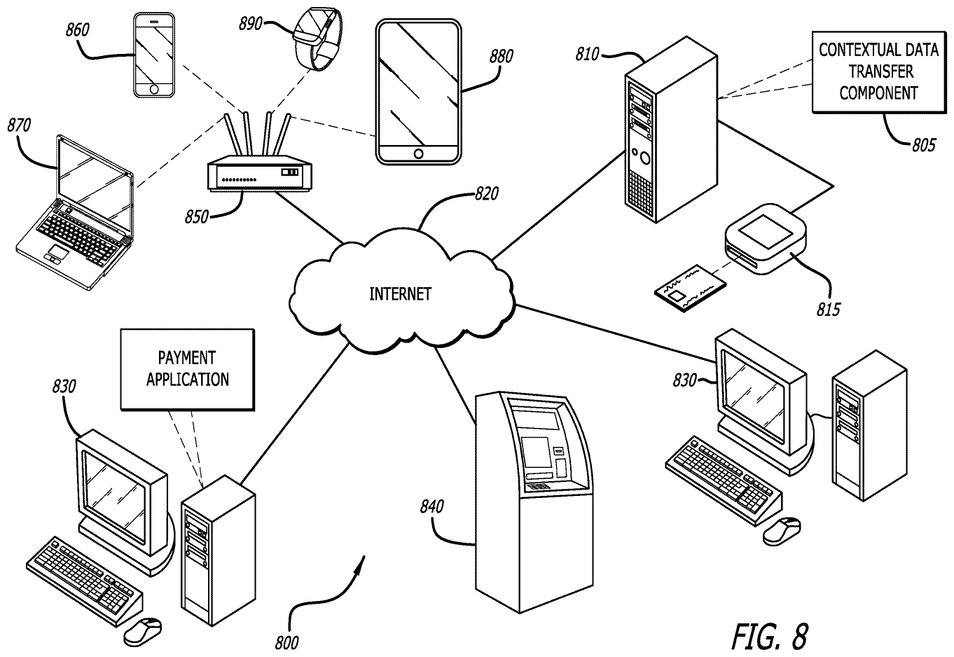

Referring to FIG. 8, a system diagram of a system 800 in accordance with various embodiments of the disclosure is shown. The system 800 can include one or multiple features, components, and/or functionalities of implementations described herein with reference to FIGS. 1-7 and 9-13. In many embodiments, the system 800 comprises a plurality of devices that are configured to transmit and receive data related to providing, recording, and processing transactions across a plurality of platforms and markets in an easily accessible user format.

These transactions can be facilitated through one or more payment services. A payment service can configure server(s) 810 that are connected through the environment and provide a means for conducting transactions between a variety of users, merchants, peers, etc. The server(s) 810 can correspond to the server(s) 102 of FIG. 1. In a variety of embodiments, server(s) 810 are connected to a network 820 such as, for example, the Internet. Server(s) 810 can have a contextual data transfer component 805 to perform operations as described above. The contextual data transfer component 805 can correspond to the contextual data transfer component 135 described above with reference to FIG. 1. Server(s) 810 can also be configured to execute various applications such as the payment application similar to the payment applications described above with respect to FIGS. 1-7.

Often, when conducting transactions, such as with a merchant, the system 800 can include a plurality of reader devices 815. These readers can utilize traditional magnetic stripe technology or can be configured for conducting transactions utilizing Near-Field Communications (NFCs) within one or more mobile computing devices. In some examples, reader device(s) 815 can be associated with one or more end user devices or another intermediate device. In some embodiments, the server(s) 810 can be connected through a second or proprietary transaction processing network. Server(s) 810 can be configured to transmit a variety of data across the network 820 to any number of computing devices such as, but not limited to, personal computers 830, automatic teller machines (ATMs) 840, and mobile computing devices including laptop computers 870, mobile phones 860, portable tablet computers 880 and wearable computing devices 890.

In additional embodiments, transaction or other user account data can be mirrored in additional cloud-based service provider servers or edge network systems as needed. In further embodiments, the transaction or user account data can be encapsulated or otherwise shrouded within a privacy barrier or localized device such as being limited to only being stored within a user's personal computing or mobile device. In still additional embodiments, the server(s) 810 can be hosted as virtual servers within a cloud-based service.

In further embodiments, the sending and receiving of transaction or user account data can occur over the network 820 through wired and/or wireless connections. In the embodiment depicted in FIG. 8, the computing devices 830, 840, 850, 860, 870, 880, 890 are connected wirelessly to the network 820 via a wireless network access point 850. It should be understood by those skilled in the art that the types of wired and/or wireless connections between devices on the system 800 can be comprised of any combination of devices and connections as needed.

In some examples, any one of the computing devices 830, 840, 850, 860, 870, 880, 890 can include a payment application, or an instance thereof, that can provide access to a user's account and the various balances they control. For example, a user can utilize a payment application on their mobile phone 860 administered by the payment service. This payment application can facilitate transactions with other users and/or merchants who may not accept the user's fiat currency. As described in more detail in the discussion of the previous figures, applications such as the payment application can facilitate the ability of users, merchants, and peers, etc. to conduct transactions between various fiat currencies frictionlessly by utilizing stablecoins and providing synthetic fiat currency.

These transactions can, in some embodiments, generate a plurality of data related to the size, type, and process of subsequent transactions that should be performed within the system 800. For example, transaction decisions (what merchant to buy from, where to transfer assets to, where to load more assets into the user account, etc.) can be generated on the user's personal computer 830 or mobile computing devices 860, 870, 880, 890 and transmitted across the network 820.

In additional embodiments, a transaction outcome (e.g., purchase $1,000 of a particular cryptocurrency) can be transmitted from a user device which is then processed by one or more network devices such as the server(s) 810 which can then generate the data and steps necessary to complete the desired transaction outcome. These customized transaction outcome responses can be generated from a list of predetermined responses within the server(s) 810, personal computers 830, ATMs 840, and/or mobile computing devices 860, 870, 880, 890. In other embodiments, the responses can be dynamically generated based on a variety of changing factors such as, but not limited to, market conditions, current transaction costs, currency availability, and/or potential purchase opportunities.

In still further embodiments, the transaction data can be stripped of personal identifying data and transmitted to the server(s) 810 and/or other cloud-based services for processing. This can be data that is limited to a personal identifying key that only the user has access to. The transaction data can then be processed by the server(s) 810 in such a way that the completed transaction is accessible by the payment service, but not others. In certain embodiments, the system 800 can process various currencies during the transaction to facilitate cross-border or multi-currency transactions. For example, the purchase of a product from a merchant that accepts USD can be achieved by a user in a non-USD currency country by purchasing one or more stablecoins that can be exchanged into USD for settlement with the merchant. In this way, the user can conduct transactions with a merchant in USD and, in some examples, the user may not made aware of the exchanges or other steps taken by the payment service. As a result, the user can receive receipt or other data that reflects the transaction. In contrast, the payment service can retain a copy of the entire transaction (including any sub- or dependent transactions) that, in certain embodiments, is accessible to the payment service and may not be accessible to other users.

In some examples, the system 800 can utilize context data associated with transactions to determine whether to perform a conversion between currencies and, if so, how such conversion is to be performed. For instance, if it is determined that an optimal path for payment warrants a conversion, the system 800 can determine which conversion(s) are warranted (e.g., USD to stablecoin, USD to stablecoin to Pesos, USD to Pesos, etc.), whether the more than one type of currency is warranted for payment, or the like. Additional details are described above.

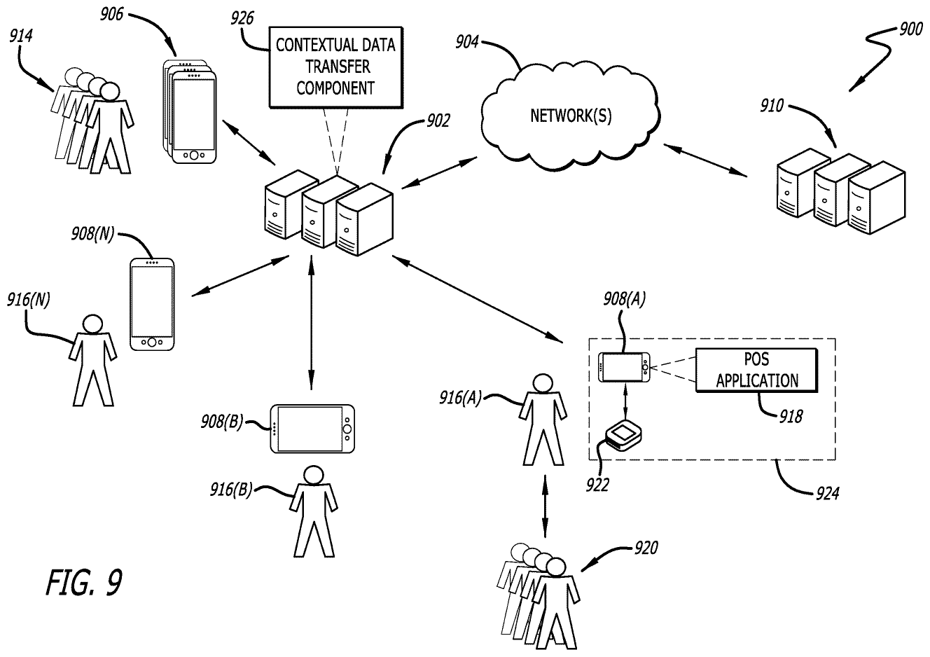

Referring to FIG. 9, an illustration of a merchant environment 900 in accordance with various embodiments of the invention is shown. The environment 900 can include one or multiple features, components, and/or functionalities of implementations described herein with reference to FIGS. 1-8 and 10-13. The environment 900 includes server(s) 902 that can communicate over a network 904 with user devices 906 (which, in some examples can be merchant devices 908 (individually, 908(A)-908(N))) and/or server(s) 910 associated with third-party service provider(s). The server(s) 902 can be associated with a service provider that can provide one or more services for the benefit of users 914, as described below. Actions attributed to the service provider can be performed by the server(s) 902. In an example, the server(s) 902 can correspond to the server(s) 102, the network 904 can correspond to the network 104, the user devices 906 can correspond to the user device 106, and the users 914 can correspond to the user 114 and/or merchant 120 of FIG. 1 above.

As discussed previously, the users 914 can conduct a series of transactions within the environment 900. These transactions can be done through one or more user devices 906 which have access to one or more user accounts. As discussed above, a user account can include a plurality of balances, wallets, or other assets. The users 914 can utilize the payment service on their user devices 906 to conduct transactions utilizing the balances and/or wallets within their user account. Likewise, merchants 916 (individually, 916(A)-916(N)) can attempt to create transactions with the users 914 throughout the environment 900. In many embodiments, the merchants can utilize their own user accounts. Through the use of these user accounts, the server(s) 902 facilitating the payment service can execute and complete transactions that require different types of currency. Likewise, these transactions can also be done in traditional point-of-sale systems 924.

In an example, the server(s) 910 can include a contextual data transfer component 926, which can correspond to the contextual data transfer component 135 of FIG. 1, to facilitate contextual data transfers as described herein. As an example, the contextual data transfer component 926 can convert a stablecoin to a fiat currency and vice versa to offer transactions in markets, jurisdictions, or other venues that would otherwise not be available to customers who typically transact in a particular fiat currency. Often, such conversions can be handled by the server(s) 902 which can facilitate transactions seamlessly for both the users 914 and the merchants 916. In this way, the service provider can be in a unique position to facilitate seamless transactions between users 914 and merchants 916. This arrangement can offer the technical benefit of easily providing increased access to markets between users 914 and merchants 916 without the need to acquire a stable access point to various fiat currencies.

The environment 900 can include a plurality of user devices 906, as described above. Each one of the plurality of user devices 906 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 914. The users 914 can be referred to as customers, buyers, merchants, merchants, borrowers, employees, employers, payors, payees, couriers and so on. The users 914 can interact with the user devices 906 via UIs presented via the user devices 906. In at least one example, a UI can be presented via a web browser, or the like. In other examples, a UI can be presented via an application, such as a mobile application or desktop application, which can be provided by the service provider or which can be an otherwise dedicated application. In some examples, individual of the user devices 906 can have an instance or versioned instance of an application, which can be downloaded from an application store, for example, which can present the UI(s) described herein. In at least one example, a user 914 can interact with the UI via touch input, spoken input, or any other type of input.

As described above, in at least one example, the users 914 can include merchants 916 (individually, 916(A)-916(N)). In an example, the merchants 916 can operate respective merchant devices 908, which can be user devices 906 configured for use by merchants 916. For the purpose of this discussion, a “merchant” can be any entity that offers items (e.g., goods or services) for purchase or other means of acquisition (e.g., rent, borrow, barter, etc.). The merchants 916 can offer items for purchase or other means of acquisition via brick-and-mortar stores, mobile stores (e.g., pop-up shops, food trucks, etc.), online stores, combinations of the foregoing, and so forth. In some examples, at least some of the merchants 916 can be associated with a same entity but can have different merchant locations and/or can have franchise/franchisee relationships. In additional or alternative examples, the merchants 916 can be different merchants. That is, in at least one example, the merchant 916(A) is a different merchant than the merchant 916(B) and/or the merchant 916(N).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN) s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 908 can have an instance of a POS application 918 stored thereon. The POS application 918 can configure the merchant device 908 as a POS terminal, which enables the merchant 916(A) to interact with one or more customers 920. As described above, the users 914 can include customers, such as the customers 920 shown as interacting with the merchant 916(A). For the purpose of this discussion, a “customer” can be any entity that acquires items from merchants. While only four customers 920 are illustrated in FIG. 9, any number of customers 920 can interact with the merchants 916. Further, while FIG. 9 illustrates the customers 920 interacting with the merchant 916(A), the customers 920 can interact with any of the merchants 916.

In at least one example, interactions between the customers 920 and the merchants 916 that involve the exchange of assets (from the customers 920) for items (from the merchants 916) can be referred to as “transactions.” In at least one example, the POS application 918 can determine transaction data associated with the POS transactions. Transaction data can include payment information, which can be obtained from a reader device 922 associated with the merchant device 908(A), user authentication data, purchase amount information, point-of-purchase information (e.g., item(s) purchased, date of purchase, time of purchase, etc.), etc. The POS application 918 can send transaction data to the server(s) 902 such that the server(s) 902 can track transactions of the customers 920, merchants 916, and/or any of the users 914 over time. Furthermore, the POS application 918 can present a UI to enable the merchant 916(A) to interact with the POS application 918 and/or the service provider via the POS application 918.

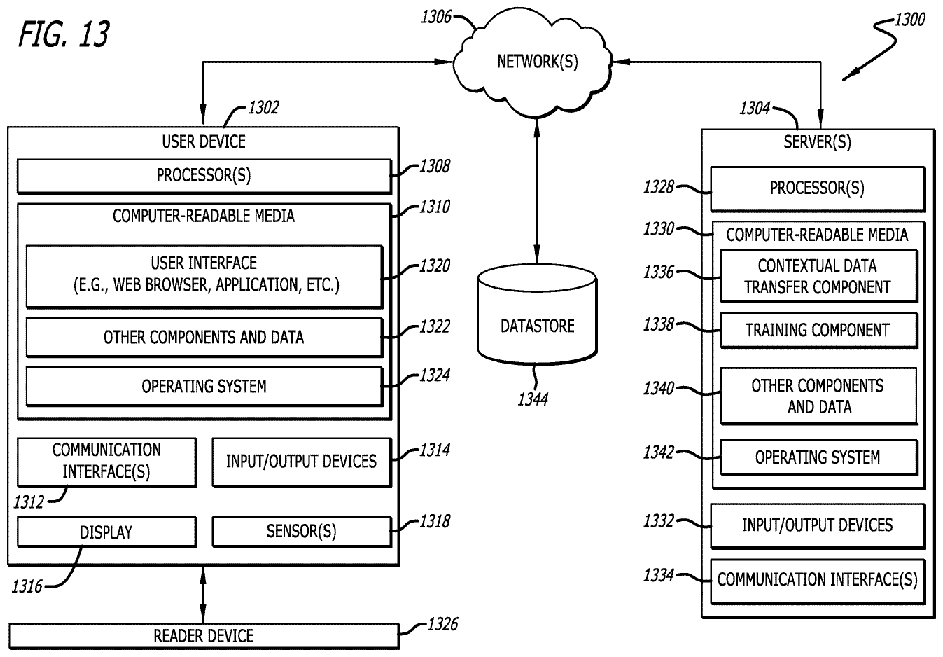

In at least one example, the merchant device 908(A) can be a special-purpose computing device configured as a POS terminal (via the execution of the POS application 918). In at least one example, the POS terminal can be connected to a reader device 922, which is capable of accepting a variety of payment instruments, such as credit cards, debit cards, gift cards, short-range communication-based payment instruments, and the like, as described below. In at least one example, the reader device 922 can plug in to a port in the merchant device 908(A), such as a microphone port, a headphone port, an audio-jack, a data port, or other suitable port. In additional or alternative examples, the reader device 922 can be coupled to the merchant device 908(A) via another wired or wireless connection, such as via a Bluetooth®, BLE, and so on. Additional details are described below with reference to FIG. 13. In some examples, the reader device 922 can read information from alternative payment instruments including, but not limited to, wristbands and the like.

In some examples, the reader device 922 can physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal can provide a rich UI, communicate with the reader device 922, and communicate with the server(s) 902, which can provide, among other services, a payment processing service. The server(s) 902 associated with the service provider can communicate with server(s) 910, as described below. In this manner, the POS terminal and reader device 922 can collectively process transaction(s) between the merchants 916 and customers 920. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement can also work in an offline-online scenario to allow one device (e.g., secondary terminal) to continue taking user input, and synchronize data with another device (e.g., primary terminal) when the primary or secondary terminal switches to online mode. In other examples, such data synchronization can happen periodically or at randomly selected time intervals.

While the POS terminal and the reader device 922 of the POS system 924 are shown as separate devices, in additional or alternative examples, the POS terminal and the reader device 922 can be part of a single device. In some examples, the reader device 922 can have a display integrated therein for presenting information to the customers 920. In additional or alternative examples, the POS terminal can have a display integrated therein for presenting information to the customers 920. POS systems, such as the POS system 924, can be mobile, such that POS terminals and reader devices can process transactions in disparate locations across the world. POS systems can be used for processing card-present transactions and card-not-present (CNP) transactions, as described below.

A card-present transaction is a transaction where both a customer 920 and his or her payment instrument are physically present at the time of the transaction. Card-present transactions can be processed by swipes, dips, taps, or any other interaction between a physical payment instrument (e.g., a card), or otherwise present payment instrument, and a reader device 922 whereby the reader device 922 is able to obtain payment data from the payment instrument. A swipe is a card-present transaction where a customer 920 slides a card, or other payment instrument, having a magnetic strip through a reader device 922 that captures payment data contained in the magnetic strip. A dip is a card-present transaction where a customer 920 inserts a payment instrument having an embedded microchip (i.e., chip) into a reader device 922 first. The dipped payment instrument remains in the payment reader until the reader device 922 prompts the customer 920 to remove the card, or other payment instrument. While the payment instrument is in the reader device 922, the microchip can create a one-time code which is sent from the POS system 924 to the server(s) 910 (which can be associated with third-party service providers that provide payment or conversion services, including but not limited to, a cryptocurrency conversion service provider, an acquirer bank, an issuer, and/or a card payment network (e.g., MasterCard®, VISA®, etc.)) to be matched with an identical one-time code. A tap is a card-present transaction where a customer 920 can tap or hover his or her payment instrument (e.g., card, electronic device such as a smart phone running a payment application, etc.) over a reader device 922 to complete a transaction via short-range communication (e.g., NFC, RFID, Bluetooth®, BLE, etc.). Short-range communication enables the payment instrument to exchange information with the reader device 922. A tap can also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 924, the server(s) 902, and/or the server(s) 910 can exchange payment information and transaction data to determine whether transactions are authorized. For example, the POS system 924 can provide encrypted payment data, user authentication data, purchase amount information, point-of-purchase information, etc. (collectively, transaction data) to server(s) 902 over the network(s) 904. The server(s) 902 can send the transaction data to the server(s) 910. As described above, in at least one example, the server(s) 910 can be associated with third-party service providers that provide payment services, including but not limited to, an acquirer bank, an issuer, and/or a card payment network (e.g., MasterCard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server(s) 910 associated therewith) can send a fund transfer request to a server computing device of a card payment network (e.g., MasterCard®, VISA®, etc.) to determine whether the transaction is authorized or deficient. In at least one example, the service provider can serve as an acquirer and connect directly with the card payment network.

The card payment network (e.g., the server(s) 910 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 910 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 910 associated therewith), and a payment authorization message is communicated from the issuer to the POS device via a path opposite of that described above, or via an alternate path.

As described above, the server(s) 910, which can be associated with payment service provider(s), can determine whether the transaction is authorized based on the transaction data, as well as information relating to parties to the transaction (e.g., the customer 920 and/or the merchant 916(A)). The server(s) 910 can send an authorization notification over the network(s) 904 to the server(s) 902, which can send the authorization notification to the POS system 924 over the network(s) 904 to indicate whether the transaction is authorized. The server(s) 902 can also transmit additional information such as transaction identifiers to the POS system 924. In one example, the server(s) 902 can include a merchant application and/or other functional components for communicating with the POS system 924 and/or the server(s) 910 to authorize or decline transactions.

Based on the authentication notification that is received by the POS system 924 from server(s) 902, the merchant 916(A) can indicate to the customer 920 whether the transaction has been approved. In some examples, approval can be indicated at the POS system 924, for example, at a display of the POS system 924. In other examples, such as with a smart phone or watch operating as a short-range communication payment instrument, information about the approved transaction can be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, cryptocurrency conversion services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 914 can access all of the services of the service provider. In other examples, the users 914 can have gradated access to the services, which can be based on risk tolerance, IDV outputs, subscriptions, and so on. In at least one example, access to such services can be availed to the merchants 916 via the POS application 918. In additional or alternative examples, each service can be associated with its own access point (e.g., application, web browser, etc.).

The service provider can offer payment processing services for processing payments on behalf of the merchants 916, as described above. For example, the service provider can provision payment processing software, payment processing hardware and/or payment processing services to merchants 916, as described above, to enable the merchants 916 to receive payments from the customers 920 when conducting POS transactions with the customers 920. For instance, the service provider can enable the merchants 916 to receive cash payments, payment card payments, and/or electronic payments from customers 920 for POS transactions and the service provider can process transactions on behalf of the merchants 916.

As the service provider processes transactions on behalf of the merchants 916, the service provider can maintain accounts or balances for the merchants 916 in one or more ledgers. For example, the service provider can analyze transaction data received for a transaction to determine an amount of funds owed to a merchant 916(A) for the transaction. In at least one example, such an amount can be a total purchase price less fees charged by the service provider for providing the payment processing services. Based on determining the amount of funds owed to the merchant 916(A), the service provider can deposit funds into an account of the merchant 916(A). The account can have a balance, which can be managed by the service provider. The account can be different from a conventional bank account at least because the balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a balance of the merchant 916(A) to a bank account of the merchant 916(A) that is held at a bank or other financial institution (e.g., associated with the server(s) 910). Scheduled deposits can occur at a prearranged time after a POS transaction is funded, which can be a business day after the POS transaction occurred, or sooner or later. In some examples, the merchant 916(A) can access funds prior to a scheduled deposit. For instance, the merchant 916(A) can have access to same-day deposits (e.g., wherein the service provider deposits funds from the balance to a linked bank account of the merchant on a same day as POS transaction, in some examples prior to the POS transaction being funded) or instant deposits (e.g., wherein the service provider deposits funds from the balance to a linked bank account of the merchant on demand, such as responsive to a request). Further, in at least one example, the merchant 916(A) can have a payment instrument that is linked to the balance that enables the merchant to access the funds without first transferring the funds from the account managed by the service provider to the bank account of the merchant 916(A).

In at least one example, the service provider can provide inventory management services. That is, the service provider can provide inventory tracking and reporting. Inventory management services can enable the merchant 916(A) to access and manage a database storing data associated with a quantity of each item that the merchant 916(A) has available (i.e., an inventory). Furthermore, in at least one example, the service provider can provide catalog management services to enable the merchant 916(A) to maintain a catalog, which can be a database storing data associated with items that the merchant 916(A) has available for acquisition (i.e., catalog management services). In at least one example, the catalog can include a plurality of data items and a data item of the plurality of data items can represent an item that the merchant 916(A) has available for acquisition. The service provider can offer recommendations related to pricing of the items, placement of items on the catalog, and multi-party fulfillment of the inventory.

In at least one example, the service provider can provide business banking services, which allow the merchant 916(A) to track deposits (from payment processing and/or other sources of funds) into an account of the merchant 916(A), payroll payments from the account (e.g., payments to employees of the merchant 916(A)), payments to other merchants (e.g., business-to-business) directly from the account or from a linked debit card, withdrawals made via scheduled deposit and/or instant deposit, etc. Furthermore, the business banking services can enable the merchant 916(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 916 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally, and/or alternatively, the service provider can offer a monthly repayment loan product, wherein a capital loan is repaid monthly, for instance, via a debit from a bank account linked to the payment processing service. The credit risk of the merchant can be evaluated using risk models that take into account factors, such as payment volume, credit risk of similarly situated merchants, past transaction history, seasonality, credit history, and so on.

Additionally, or alternatively, the service provider can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 916. The service provider can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the service provider associates capital to a merchant or customer's debit card, where the use of the debit card is defined by the terms of the loan. In some examples, the merchant can only use the debit card for making specific purchases. In other examples, the “installment” associated with the loan product is credited directly via the payment instrument. The payment instrument is thus customized to the loan and/or the parties associated with the loan.

The service provider can provide web-development services, which enable users 914 who are unfamiliar with HTML, XML, JavaScript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 916. In at least one example, the service provider can recommend and/or generate content items to supplement omni-channel presences of the merchants 916. That is, if a merchant of the merchants 916 has a web page, the service provider—via the web-development or other services—can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider.

Moreover, in at least one example, the service provider can provide employee management services for managing schedules of employees. Further, the service provider can provide appointment services for enabling users 914 to set schedules for scheduling appointments and/or users 914 to schedule appointments.

In some examples, the service provider can provide restaurant management services to enable users 914 to make and/or manage reservations, to monitor front-of-house and/or back-of-house operations, and so on. In such examples, the merchant device(s) 908 and/or server(s) 902 can be configured to communicate with one or more other computing devices, which can be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider can provide fulfilment services, which can use couriers for delivery, wherein couriers can travel between multiple locations to provide delivery services, photography services, etc. Couriers can be users 914 who can travel between locations to perform services for a requesting user 914 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via UI (e.g., application, web browser, or other access point) presented via respective devices 906.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider can enable conversational commerce via conversational commerce services, which can use one or more machine learning mechanisms to analyze messages exchanged between two or more users 914, voice inputs into a virtual assistant or the like, to determine intents of user(s) 914. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 914 can be new to the service provider such that the user 914 that has not registered (e.g., subscribed to receive access to one or more services offered by the service provider) with the service provider. The service provider can offer onboarding services for registering a potential user 914 with the service provider. In some examples, onboarding can involve presenting various questions, prompts, and the like to a potential user 914 to obtain information that can be used to generate a profile for the potential user 914. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 914 providing all necessary information, the potential user 914 can be onboarded to the service provider. In such an example, any limited or short-term access to services of the service provider can be transitioned to more permissive (e.g., less limited) or longer-term access to such services.

The service provider can be associated with IDV services, which can be used by the service provider for compliance purposes and/or can be offered as a service, for instance to third-party service providers (e.g., associated with the server(s) 910). That is, the service provider can offer IDV services to verify the identity of users 914 seeking to use or using their services. Identity verification requires a customer (or potential customer) to provide information that is used by compliance departments to prove that the information is associated with an identity of a real person or entity. In at least one example, the service provider can perform services for determining whether identifying information provided by a user 914 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 910 associated with third-party service providers. Such third-party service providers can provide information that enables the service provider to provide services, such as those described above. In additional or alternative examples, such third-party service providers can access services of the service provider. That is, in some examples, the third-party service providers can be subscribers, or otherwise access, services of the service provider.

Techniques described herein can be configured to operate in both real-time/online and offline modes. “Online” modes refer to modes when devices are capable of communicating with the service provider (e.g., the server(s) 902) and/or the server(s) 910 via the network(s) 904. In some examples, the merchant device(s) 908 are not capable of connecting with the service provider (e.g., the server(s) 902) and/or the server(s) 910, due to a network connectivity issue, for example. In additional or alternative examples, the server(s) 902 are not capable of communicating with the server(s) 910 due to network connectivity issue, for example. In such examples, devices can operate in “offline” mode where at least some payment data is stored (e.g., on the merchant device(s) 908) and/or the server(s) 902 until connectivity is restored and the payment data can be transmitted to the server(s) 902 and/or the server(s) 910 for processing.

In at least one example, the service provider can be associated with a hub, such as an order hub, an inventory hub, a fulfillment hub and so on, which can enable integration with one or more additional service providers (e.g., associated with the additional server(s) 910). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 906 that are in communication with one or more server(s) 902 of the service provider. That is, techniques described herein are directed to a specific implementation—or, a practical application—of utilizing a distributed system of user devices 906 that are in communication with one or more server(s) 902 of the service provider to perform a variety of services, as described above. The unconventional configuration of the distributed system described herein enables the server(s) 902 that are remotely-located from end-users (e.g., users 914) to intelligently offer services based on aggregated data associated with the end-users, such as the users 914 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical UIs (GUIs) can be presented to facilitate techniques described herein. Some of the techniques described herein are directed to UI features presented via GUIs to improve interaction between users 914 and user devices 906. Furthermore, such features are changed dynamically based on the profiles of the users involved interacting with the GUIs. As such, techniques described herein are directed to improvements to computing systems.

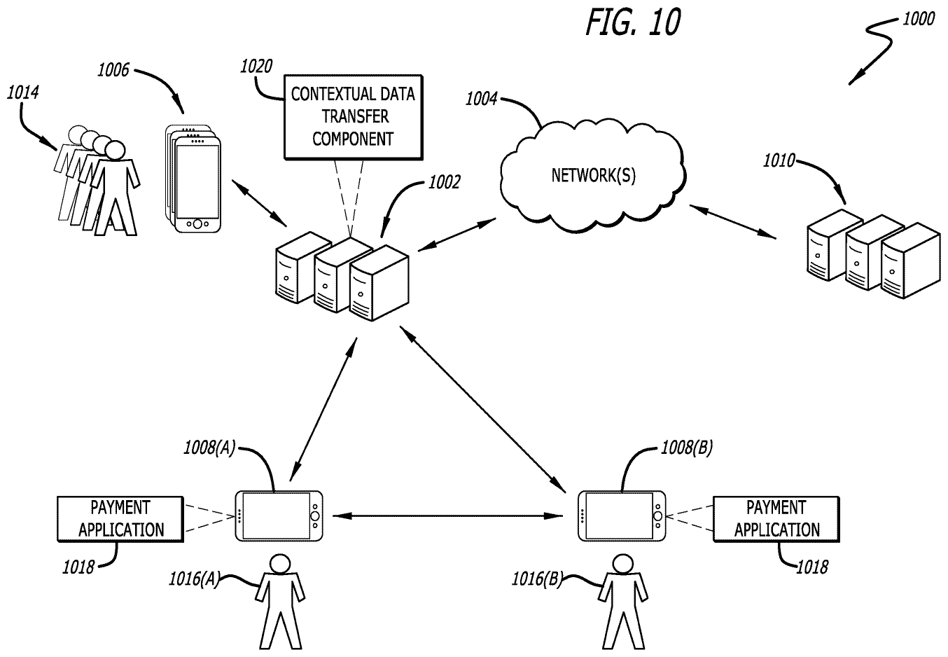

Referring to FIG. 10, an illustration of a peer-to-peer environment 1000 in accordance with various embodiments of the invention is shown. The environment 1000 can include one or multiple features, components, and/or functionalities of implementations described herein with reference to FIGS. 1-9 and 11-13. The environment 1000 includes server(s) 1002 that can communicate over a network 1004 with user devices 1006 (which, in some examples can be user devices 1008 (individually, 1008(A), 1008(B)) and/or server(s) 1010 associated with third-party service provider(s) such as a cryptocurrency exchange system. The server(s) 1002 can be associated with a service provider that can provide one or more services for the benefit of users 1014, as described below. Actions attributed to the service provider can be performed by the server(s) 1002. In some examples, the service provider referenced in FIG. 9 can be the same or different than the service provider referenced in FIG. 10. In an example, the server(s) 1002 can correspond to the server(s) 102, the network 1004 can correspond to the network 104, the user devices 1006 can correspond to the user device 106, and the users 1014 can correspond to the user 114 and/or merchant 120 of FIG. 1 above.

Also similar to FIG. 9, the transactions in many examples can utilize the conversion to a stablecoin from a fiat currency to allow for transactions in markets, jurisdictions, or other venues that would otherwise not be available between users 1016(A), 1016(B) who typically would not transact due to differences between their native fiat currency. Often, these stablecoin conversions can be handled by a contextual data transfer component 1020, which can correspond to the contextual data transfer component 135, associated with the server(s) 1002, which can present the transaction seamlessly to both the users 1016(A), 1016(B) such that each user believes that they are transacting in their native fiat currency. In other examples, at least one user 1016(A), 1016(B) has at least a stablecoin balance within their user account and receives payments from non-native fiat currencies in stablecoins. For these examples, the contextual data transfer component 1020 automatically detects that a stablecoin conversion should occur once differing native fiat currency balances within the user accounts are detected. This can be seamlessly done when both users 1016(A), 1016(B) have accounts and/or user accounts with the service provider. Because of this, the service provider can be in a unique position to generate these seamless transactions between users 1016(A), 1016(B) with differing fiat currencies through stablecoin conversions and/or payments. This arrangement can offer the technical benefit of easily providing increased access to markets between users 1016(A), 1016(B) without the need to convert or acquire a stable access point to various fiat currencies.

The environment 1000 can include a plurality of user devices 1006, as described above. Each one of the plurality of user devices 1006 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 1014.

The users 1014 can be referred to as customers, buyers, merchants, merchants, borrowers, employees, employers, payors, payees, couriers and so on. The users 1014 can interact with the user devices 1006 via UIs presented via the user devices 1006. The user devices 1006 can be utilized to execute a payment service application. The payment service application can be configured to provide the user access to one or more user accounts. As described below, the user accounts can allow for conducting transactions such as with other users/peers.

In at least one example of the payment service application, a UI can be presented via a web browser, or the like. In other examples, a UI can be presented via an application, such as a mobile application or desktop application, which can be provided by the service provider, or which can be an otherwise dedicated application. In some examples, individual of the user devices 1006 can have an instance or versioned instance of an application, which can be downloaded from an application store, for example, which can present the UI(s) described herein. In at least one example, a user 1014 can interact with the UI via touch input, spoken input, or any other type of input.

In at least one example, the service provider can provide a peer-to-peer payment service that enables peer-to-peer payments between two or more users 1014. Two users, user 1016(A) and user 1016(B) are illustrated in FIG. 10 as “peers” in a peer-to-peer payment. In at least one example, the service provider can communicate with instances of a payment application 1018 (or other access point) installed on devices 1006 configured for operation by users 1014. In an example, an instance of the payment application 1018 executing on a first device 1008(A) operated by a payor (e.g., user 1016(A)) can send a request to the service provider to transfer an asset (e.g., fiat currency, non-fiat currency, cryptocurrency, securities, gift cards, and/or related assets) from the payor to a payee (e.g., user 1016(B)) via a peer-to-peer payment. In some examples, assets associated with an account of the payor are transferred to an account of the payee. In some examples, assets can be held at least temporarily in an account of the service provider prior to transferring the assets to the account of the payee.

In a number of embodiments, the payor user 1016(A) and the payee user 1016(B) each have a user account. Payment between these peers can occur, even if each user utilizes a different fiat currency, or even different asset types. For example, the payor user 1016(A) can have a user account that includes a wallet in dollars, while the payee user 1016(B) has a user account that includes a wallet in pesos. The payor user 1016(A) can also have an additional stablecoin balance in their user account. The payee user 1016(B) can send a payment request in pesos. Then, the requested amount appears in dollars on the payor users 1016(A) interface. The payor user 1016(A) approves this payment and the payment service can determine which is the best method for payment. In certain situations, the dollar balance can have the best conversion rate, while the stablecoin balance can have a better conversion rate currently. Therefore, the payment service deducts, converts, and credits the necessary currencies without further input from either of the users 1016(A), 1016(B).

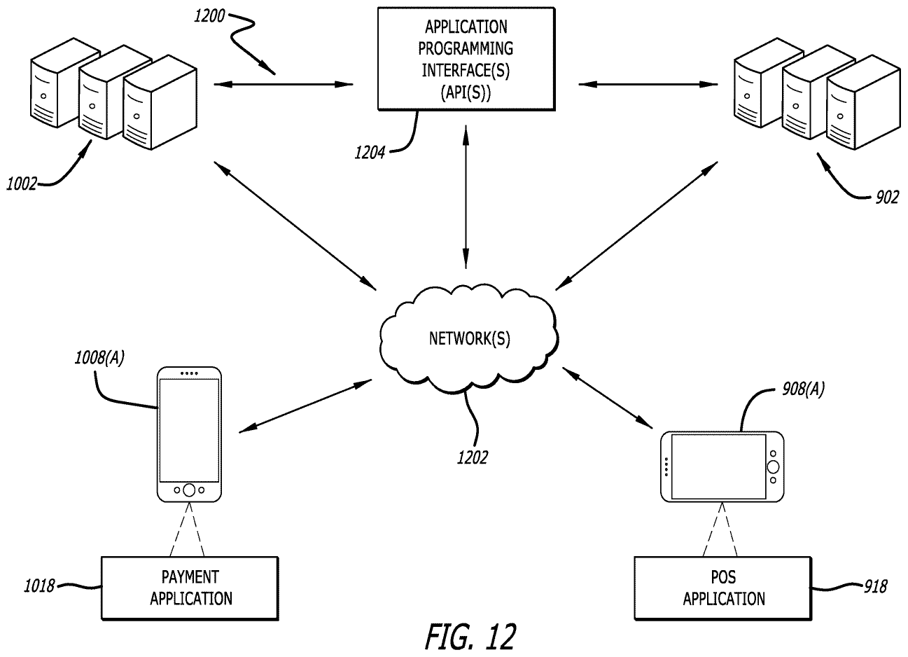

In some examples, the service provider can utilize a ledger system to track transfers of assets between users 1016. FIG. 12, below, provides additional details associated with such a ledger system. The ledger system can enable users 1016 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 1018 executing on user device(s) of payee(s). As an example, the service provider can transfer assets from an account of user 1016(A) to an account of the user 1016(B) and can send a notification to the user device 1008(B) of the user 1016(B) for presentation via a UI. The notification can indicate that a transfer is in process, a transfer is complete, or the like. In some examples, the service provider can send additional or alternative information to the instances of the payment application 1018 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that can be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 1002 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan ( [symbol] ), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 1018 executing on the user devices 1006. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider can be the service provider as described with reference to FIG. 10 or a third-party service provider associated with the server(s) 1010. In examples where the content provider is a third-party service provider, the server(s) 1010 can be accessible via one or more APIs or other integrations. The forum can be employed by a content provider to enable users of the forum to interact with one another (e.g., through creating messages, posting comments, etc.). In some examples, “forum” can also refer to an application or webpage of an e-commerce or retail organization that offers products and/or services. Such websites can provide an online “form” to complete before or after the products or services are added to a virtual cart. The online form can include one or more fields to receive user interaction and engagement. Examples include name and other identification of the user, shipping address of the user, etc. Some of these fields can be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 10. For instance, the service provider can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication.

The messaging application can be executed on a user device 1006 (e.g., mobile device or conventional personal computer (PC)) based on instructions transmitted to and from the server(s) 1002 (which, in such an example can be called a “messaging server”). In some instances, the messaging application can include a payment application with messaging capability that enables users of the payment application to communicate with one another. In such instances, the payment application can be executed on a user device 1006 based on instructions transmitted to and from the server(s) 1002 (e.g., the payment service discussed in this description or another payment service that supports payment transactions). In some examples, the messaging application can be provided by a third-party service provider associated with the server(s) 1010. In examples where the messaging application is a third-party service provider, the server(s) 1010 can be accessible via one or more APIs or other integrations.

As described above, the service provider can facilitate peer-to-peer transactions, which can enable users 1016 to transfer fiat currency, non-fiat currency, cryptocurrency, securities, or other assets, or portions thereof, to other users 1016. In at least one example, individual users can be associated with user accounts. Additional details associated with user accounts and the transfer of assets between users 1016 are described below with reference to FIG. 12.

Furthermore, the service provider of FIG. 10 can enable users 1016 to perform banking transactions via instances of the payment application 1018. For example, users can configure direct deposits or other deposits for adding assets to their various ledgers/balances. Further, users 1016 can configure bill pay, recurring payments, and/or the like using assets associated with their accounts. In addition to sending and/or receiving assets via peer-to-peer transactions, users 1016 buy and/or sell assets via asset networks such as cryptocurrency networks, securities networks, and/or the like.

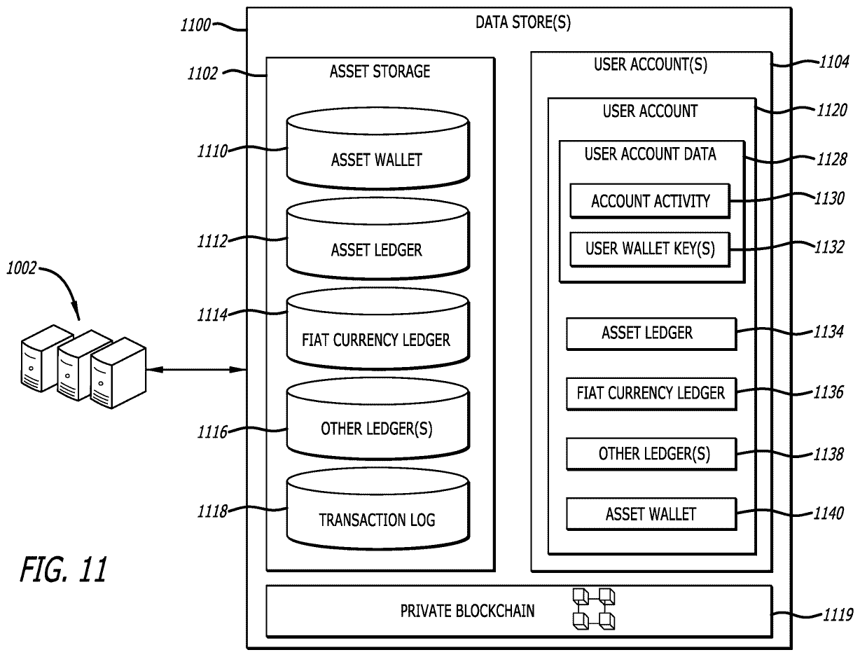

Referring to FIG. 11, a block diagram of a data store that can be associated with one or more payment service servers 1002 in accordance with various embodiments of the invention is shown. The server(s) 1002 can include one or multiple features, components, and/or functionalities of implementations described herein with reference to FIGS. 1-10 and 12-13. In at least one example, the data store(s) 1100 can store assets in an asset storage 1102, as well as data in user account(s) 1104, merchant account(s), and/or customer account(s). In at least one example, the asset storage 1102 can be used to store assets managed by the service provider of FIG. 10. In at least one example, the asset storage 1102 can be used to record whether individual of the assets are registered to users. For example, the asset storage 1102 can include an asset wallet 1110 for storing records of assets owned by the service provider of FIG. 10, such as cryptocurrency, securities, or the like, and communicating with one or more asset networks, such as cryptocurrency networks, securities networks, or the like. In some examples, the asset network can be a first-party network or a third-party network, such as a cryptocurrency exchange system or the stock market. In examples where the asset network is a third-party network, the server(s) 910 can be associated therewith. In some examples, the asset wallet 1110 can communication with the asset network via one or more components associated with the server(s) 1002.

The asset wallet 1110 can be associated with one or more addresses and can vary addresses used to acquire assets (e.g., from the asset network(s)) so that its holdings are represented under a variety of addresses on the asset network. In examples where the service provider of FIG. 10 has its own holdings of cryptocurrency (e.g., in the asset wallet 1110), a user can acquire cryptocurrency directly from the service provider of FIG. 10. In some examples, the service provider of FIG. 10 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 1102 can contain ledgers that store records of assignments of assets to users 914. Specifically, the asset storage 1102 can include asset ledger 1112, fiat currency ledger 1114, and other ledger(s) 1116, which can be used to record transfers of assets between users 914 of the service provider and/or one or more third parties (e.g., merchant network(s), payment card network(s), ACH network(s), equities network(s), the asset network, securities networks, etc.). In doing so, the asset storage 1102 can maintain a running balance of assets managed by the service provider of FIG. 10. The ledger(s) of the asset storage 1102 can further indicate some of the running balance for each of the ledger(s) stored in the asset storage 1102 is assigned or registered to one or more user account(s) 1104.

In at least one example, the asset storage 1102 can include transaction logs 1118, which can include records of past transactions involving the service provider of FIG. 10. In at least one example, transaction data, as described herein, can be stored in association with the transaction logs 1118.

In some examples, the data store(s) 1100 can store a private blockchain 1119. A private blockchain 1119 can function to record sender addresses, recipient addresses, public keys, values of cryptocurrency transferred, and/or can be used to verify ownership of cryptocurrency tokens to be transferred. In some examples, the service provider of FIG. 10 can record transactions taking place within the service provider of FIG. 10 involving cryptocurrency until the number of transactions has exceeded a determined limit (e.g., number of transactions, storage space allocation, etc.). Based at least in part on determining that the limit has been reached, the service provider of FIG. 10 can publish the transactions in the private blockchain 1119 to a public blockchain (e.g., associated with the asset network), where miners can verify the transactions and record the transactions to blocks on the public blockchain. In at least one example, the service provider of FIG. 10 can participate as miner(s) at least for its transactions to be posted to the public blockchain.

In at least one example, the data store(s) 1100 can store and/or manage accounts, such as user account(s) 1104, merchant account(s), and/or customer account(s). In at least one example, the user account(s) 1104 can store records of user accounts associated with the users 914. In at least one example, the user account(s) 1104 can include a user account 1120, which can be associated with a user (of the users 914). Other user accounts of the user account(s) 1104 can be similarly structured to the user account 1120, according to some examples. In other examples, other user accounts can include more or less data and/or account information than that provided by the user account 1120. In at least one example, the user account 1120 can include user account data 1128, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1128 can include account activity 1130 and user wallet key(s) 1132. The account activity 1130 can include a transaction log for recording transactions associated with the user account 1120. In some examples, the user wallet key(s) 1132 can include a public-private key-pair and a respective address associated with the asset network or other asset networks. In some examples, the user wallet key(s) 1132 can include one or more key pairs, which can be uni3ue to the asset network or other asset networks.

In addition to the user account data 1128, the user account 1120 can include ledger(s) for account(s) managed by the service provider of FIG. 10, for the user. For example, the user account 1120 can include an asset ledger 1134, a fiat currency ledger 1136, and/or one or more other ledgers 1138. The ledger(s) can indicate that a corresponding user utilizes the service provider of FIG. 10 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 10. In some examples, each ledger can represent a “balance” associated with a user account.

In some examples, the asset ledger 1134 can store a balance for each of one or more cryptocurrencies (e.g., Bitcoin, Ethereum, Litecoin, etc.) registered to the user account 1120. In at least one example, the asset ledger 1134 can further record transactions of cryptocurrency assets associated with the user account 1120. For example, the user account 1120 can receive cryptocurrency from the asset network using the user wallet key(s) 1132. In some examples, the user wallet key(s) 1132 can be generated for the user upon request. User wallet key(s) 1132 can be requested by the user in order to send, exchange, or otherwise control the balance of cryptocurrency held by the service provider of FIG. 10 (e.g., in the asset wallet 1110) and registered to the user. In some examples, the user wallet key(s) 1132 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 10 and the value is credited as a balance in asset ledger 1134), by purchasing currency in the form associated with the account using currency in a different form (e.g., buying a value of cryptocurrency from the service provider of FIG. 10 using a value of fiat currency reflected in fiat currency ledger 206, and crediting the value of cryptocurrency in asset ledger 1134), or by conducting a transaction with another user (customer or merchant) of the service provider of FIG. 10 wherein the account receives incoming currency (which can be in the form associated with the account or a different form, in which the incoming currency can be converted to the form associated with the account). In some examples, the user account data 1128 can include preferences for maintaining balances of individual of the ledgers. For example, the service provider of FIG. 10 can automatically debit the fiat currency ledger 1136 to increase the asset ledger 1134, or another account associated with the user whenever the cryptocurrency balance (e.g., of the asset ledger 1134) falls below a stated level (e.g., a threshold). Conversely, in some embodiments, the service provider of FIG. 10 can automatically credit the fiat currency ledger 1136 to decrease the asset ledger 1134 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user can have a balance of cryptocurrency stored in another cryptocurrency wallet. In some examples, the other cryptocurrency wallet can be associated with a third-party (e.g., associated with the third-party server(s) 1002) unrelated to the service provider of FIG. 10 (i.e., an external account). In at least one example, the user can transfer all or a portion of a balance of the cryptocurrency stored in the third-party cryptocurrency wallet to the service provider of FIG. 10. Such a transaction can require the user to transfer an amount of the cryptocurrency in a message signed by user's private key to an address provided by the service provider of FIG. 10. In at least one example, the transaction can be sent to miners to bundle the transaction into a block of transactions and to verify the authenticity of the transactions in the block. Once a miner has verified the block, the block is written to a public, distributed blockchain where the service provider of FIG. 10 can then verify that the transaction has been confirmed and can credit the user's asset ledger 1134 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 10. As described above, in some examples, the service provider of FIG. 10 can acquire cryptocurrency from a third-party source (e.g., associated with the third-party server(s) 1010). In such examples, the asset wallet 1110 can be associated with different addresses and can vary addresses used to acquire cryptocurrency so that its holdings are represented under a variety of addresses on a blockchain. When the service provider of FIG. 10 has their own holdings of cryptocurrency, users can acquire cryptocurrency directly from the service provider of FIG. 10. In some examples, the service provider of FIG. 10 can include logic for buying and selling cryptocurrency in order to maintain a desired level of cryptocurrency. The desired level can be based on a volume of transactions over a period, balances of collective user accounts, cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider of FIG. 10 has its own cryptocurrency assets, cryptocurrency transferred in a transaction (e.g., data with address provided for receipt of transaction and a balance of cryptocurrency transferred in the transaction) can be stored in the asset wallet 1110. In at least one example, the service provider of FIG. 10 can credit the asset ledger 1134 of the user. Additionally, while the service provider of FIG. 10 recognizes that the user retains the value of the transferred cryptocurrency through crediting the asset ledger 1134, any person that inspects the blockchain will see the cryptocurrency as having been transferred to the service provider of FIG. 10. In some examples, the asset wallet 1110 can be associated with many different addresses. In such examples, any person that inspects the blockchain may not easily associate all cryptocurrency stored in asset wallet 1110 as belonging to the same entity. It is this presence of a private ledger that is used for real-time transactions and maintained by the service provider of FIG. 10, combined with updates to the public ledger at other times, that allows for extremely fast transactions using cryptocurrency to be achieved. In some examples, the “private ledger” can refer to the asset ledger 1112, which in some examples, can utilize the private blockchain 1119, as described herein. The “public ledger” can correspond to a public blockchain associated with the asset network.

In at least one example, a user's asset ledger 1134, fiat currency ledger 1136, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1134. In some examples, a user can receive fiat currency or another currency in the form of payment for a transaction with another user. In at least one example, at least a portion of such funds can be converted into cryptocurrency by the service provider of FIG. 10 and used to fund the asset ledger 1134 of the user.

As addressed above, in some examples, users can also have other accounts maintained by the service provider of FIG. 10. For example, a user can also have an account in U.S. dollars, which can be tracked, for example, via the fiat currency ledger 1136. Such an account can be funded by transferring money from a bank account at a third-party bank to an account maintained by the service provider of FIG. 10 as is conventionally known. In some examples, a user can receive fiat currency in the form of payment for a transaction with another user. In such examples, at least a portion of such funds can be used to fund the fiat currency ledger 1136.

In some examples, a user can have one or more internal payment cards registered with the service provider of FIG. 10. Internal payment cards can be linked to one or more of the accounts associated with the user account 1120. In some embodiments, options with respect to internal payment cards can be adjusted and managed using an application (e.g., the payment application 1018).

In at least one example, as described above, each ledger can correspond to an account of the user that is managed by the service provider of FIG. 10. In at least one example, individual of the accounts can be associated with a wallet or a balance for use in payment transactions, peer-to-peer transactions, payroll payments, etc.

In at least one example, the user account 1120 can be associated with an asset wallet 1140. The asset wallet 1140 of the user can be associated with account information that can be stored in the user account data 1128 and, in some examples, can be associated with the user wallet key(s) 1132. In at least one example, the asset wallet 1140 can store data indicating an address provided for receipt of a cryptocurrency transaction. In at least one example, the balance of the asset wallet 1140 can be based at least in part on a balance of the asset ledger 1134. In at least one example, assets availed via the asset wallet 1140 can be stored in the asset wallet 1140 or the asset wallet 1110. Assets availed via the asset wallet 1110 can be tracked via the asset ledger 1134. The asset wallet 1140, however, can be associated with additional cryptocurrency assets.

In at least one example, when the service provider of FIG. 10 includes a private blockchain 1119 for recording and validating cryptocurrency transactions, the asset wallet 1140 can be used instead of, or in addition to, the asset ledger 1134. For example, at least one example, a merchant can provide the address of the asset wallet 1140 for receiving payments. In an example where a customer is paying in cryptocurrency and the customer has their own cryptocurrency wallet account associated with the service provider of FIG. 10, the customer can send a message signed by its private key including its wallet address (i.e., of the customer) and identifying the cryptocurrency and value to be transferred to the merchant's asset wallet 1140. The service provider of FIG. 10 can complete the transaction by reducing the cryptocurrency balance in the customer's cryptocurrency wallet and increasing the cryptocurrency balance in the merchant's asset wallet 1140. In addition to recording the transaction in the respective cryptocurrency wallets, the transaction can be recorded in the private blockchain 1119 and the transaction can be confirmed. A user can perform a similar transaction with cryptocurrency in a peer-to-peer transaction as described above. In at least one example, the cryptocurrency wallet account can be funded by a balance transfer from a third-party cryptocurrency wallet, as described above. Such a transaction can require a user to transfer an amount of cryptocurrency in a message signed by the user's private key to an address of the cryptocurrency wallet account. The transferred amount of cryptocurrency can then be within the cryptocurrency wallet account for use in later transactions.

While the asset ledger 1134 and/or asset wallet 1140 are each described above with reference to cryptocurrency, the asset ledger 1134 and/or asset wallet 1140 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider of FIG. 10 is an aspect of the technology disclosed that enables technical advantages of increased processing speed and improved security.

Referring to FIG. 12 an illustration of an integrated transaction environment configured to enable point-of-sale transactions utilizing peer-to-peer assets in accordance with various embodiments of the invention is shown. In many embodiments, the environment 1200 provides that the environment 900 and the environment 1200 can be integrated to enable payments at the point-of-sale using assets associated with user accounts in the peer-to-peer environment of FIG. 10. As illustrated, each of the components can communicate with one another via one or more networks 1202. In some examples, one or more APIs 1204 or other functional components can be used to facilitate such communication.

In at least one example, the example environment 1200 can enable contactless payments, via integration of peer-to-peer payment, or other payment making, platform(s) and payment processing platform(s), are described herein. For the purpose of FIG. 12, the environment 1200 can refer to a payment processing platform and the environment 1200 can refer to a peer-to-peer payment, or payment making, platform. In an example, such an integration can enable a customer to participate in a transaction via their own computing device instead of interacting with a merchant device of a merchant, such as the merchant device 908(A). In such an example, the POS application 918, associated with a payment processing platform and executable by the merchant device 908(A) of the merchant, can present a Quick Response (QR) code, or other code that can be used to identify a transaction (e.g., a transaction code), in association with a transaction between the customer and the merchant. The QR code, or other transaction code, can be provided to the POS application 918 via an API associated with the peer-to-peer payment platform. In an example, the customer can utilize their own computing device, such as the user device 1008(A), to capture the QR code, or the other transaction code, and to provide an indication of the captured QR code, or other transaction code, to server(s) 902 and/or server(s) 1002.

Based at least in part on the integration of the peer-to-peer payment platform and the payment processing platform (e.g., via the API), the server(s) 902 and/or 1002 associated with each can exchange communications with each other—and with a payment application 1018 associated with the peer-to-peer payment platform and/or the POS application 918—to process payment for the transaction using a peer-to-peer payment where the customer is a first “peer” and the merchant is a second “peer.” In at least one example, the peer-to-peer payment platform can transfer assets from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QR code, or other transaction code, specific to the transaction can be used for providing transaction details, location details, customer details, or the like to a computing device of the customer, such as the user device 1208(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1008(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or balance. Funds associated with the payment instrument or balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 918 and the payment application 1018, as described herein, can process a payment transaction by routing information input via the merchant application to the payment application for completing a “frictionless” payment. This can be referred to as “in-application payment.” In another example of “in-application payment,” the payment application described herein can be created or modified via a software developer kit (SDK) to enable in-application payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 1208(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 918, associated with a payment processing platform, on the merchant device 908(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 908(A) can present a QR code, or other transaction code, that can be associated with a peer-to-peer payment platform. The customer can use a camera associated with the user device 1008(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a balance of the customer, that is managed and/or maintained by the peer-to-peer payment platform, to a balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 1218, associated with a payment processing platform, on the merchant device 908(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 918 can cause a text message with a resource locator (e.g., uniform resource locator (URL)) that can be associated with a peer-to-peer payment platform to be sent to the user device 1008(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction—between the customer and the resource locator presented via the customer computing device—can trigger communications between the peer-to-peer payment platform and the payment processing platform (e.g., via an API) to facilitate a transfer of funds from a balance of the customer, that is managed and/or maintained by the peer-to-peer payment platform, to a balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 1208(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a balance of the customer, that is managed and/or maintained by the peer-to-peer payment platform, to a balance of the merchant, that is managed and/or maintained by the payment processing platform. As such, the customer can use such funds for contactless payment of the transaction. Such a payment can be structured as a peer-to-peer payment wherein the customer is the first “peer”, and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 918 of a merchant device 908(A) at a brick-and-mortar store of a merchant to a payment application 1018 of a user device 1008(A) of a customer to enable the customer to participate in a transaction via their own computing device. For instance, in a “scan to pay” example as described above, based at least in part on capturing the QR code, or other transaction code, via the user device 1008(A), the payment processing platform can provide transaction data to the peer-to-peer payment platform for presentation via the payment application 1018 on the user device 1008(A). In some examples, the customer can watch items being added to their cart (e.g., via a UI presented via the payment application). As an item is added to a virtual cart by the merchant—via the POS application 918 on the merchant device 908(A) of the merchant—the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 1018 for presentation via a UI associated therewith. In addition to enabling a customer to participate in a transaction during cart building, techniques described herein can enable a customer to complete a transaction, and in some examples, provide gratuity (i.e., a tip), feedback, loyalty information, or the like, via the user device 1008(A) during or after payment of the transaction.

In some examples, based at least in part on capturing the QR code, or other transaction code, the payment processing platform can provide transaction data to the peer-to-peer payment platform for presentation via the payment application 1018 on the computing device of the customer, such as the user device 1008(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the balance (e.g., implicitly or explicitly) of the customer, the peer-to-peer payment platform can transfer funds from the balance of the customer to the payment processing platform. In at least one example, the payment processing platform can deposit the funds, or a portion thereof, into a balance of the merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a UI associated with the payment application 1018 such that the customer can provide gratuity, feedback, loyalty information, or the like, via an interaction with the UI. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the UI presented by the payment application, which can be associated with the transaction.

As described above—and also below—techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection UI being presented via the POS application 918, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1018 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

Referring to FIG. 13, a block diagram of a transaction system 1300 configured to facilitate transactions in accordance with various embodiments of the invention is shown. The transaction system 1300 can include one or multiple features, components, and/or functionalities of implementations described herein with reference to FIGS. 1-12. The system 1300 includes a user device 1302, that communicates with server computing device(s) (e.g., server(s) 1304) via network(s) 1306 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1302 is illustrated, in additional or alternate examples, the system 1300 can have multiple user devices, as described above with reference to FIG. 9.

In at least one example, the user device 1302 can be any suitable type of computing device, e.g., portable, semi-portable, semi-stationary, or stationary. Some examples of the user device 1302 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 1302 can be any computing device capable of sending communications and performing the functions according to the techniques described herein. The user device 1302 can include devices, e.g., payment card readers, or components capable of accepting payments, as described below.

In the illustrated example, the user device 1302 includes one or more processors 1308, one or more computer-readable media 1310, one or more communication interface(s) 1312, one or more input/output (I/O) devices 1314, a display 1316, and sensor(s) 1318.

In at least one example, each processor 1308 can itself comprise one or more processors or processing cores. For example, the processor(s) 1308 can be implemented as one or more microprocessors, microcomputers, microcontrollers, digital signal processors, central processing units, state machines, logic circuitries, and/or any devices that manipulate signals based on operational instructions. In some examples, the processor(s) 1308 can be one or more hardware processors and/or logic circuits of any suitable type specifically programmed or configured to execute the algorithms and processes described herein. The processor(s) 1308 can be configured to fetch and execute computer-readable processor-executable instructions stored in the computer-readable media 1310.

Depending on the configuration of the user device 1302, the computer-readable media 1310 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1310 can include, but is not limited to, RAM, ROM, EEPROM, flash memory, solid-state storage, magnetic disk storage, optical storage, and/or other computer-readable media technology. Further, in some examples, the user device 1302 can access external storage, such as RAID storage systems, storage arrays, network attached storage, storage area networks, cloud storage, or any other medium that can be used to store information and that can be accessed by the processor(s) 1308 directly or through another computing device or network. Accordingly, the computer-readable media 1310 can be computer storage media able to store instructions, components or components that can be executed by the processor(s) 1308. Further, when mentioned, non-transitory computer-readable media exclude media such as energy, carrier signals, electromagnetic waves, and signals per se.

The computer-readable media 1310 can be used to store and maintain any number of functional components that are executable by the processor(s) 1308. In some implementations, these functional components comprise instructions or programs that are executable by the processor(s) 1308 and that, when executed, implement operational logic for performing the actions and services attributed above to the user device 1302. Functional components stored in the computer-readable media 1310 can include a UI 1320 to enable users to interact with the user device 1302, and thus the server(s) 1304 and/or other networked devices. In at least one example, the UI 1320 can be presented via a web browser, payment application, or the like. In other examples, the UI 1320 can be presented via an application, such as a mobile application or desktop application, which can be provided by a service provider associated with the server(s) 1304, or which can be an otherwise dedicated application. In some examples, the UI 1320 can be configured to display one or more different types of currencies available within a user's or merchant's user account. In at least one example, a user can interact with the UI via touch input, spoken input, gesture, or any other type of input. The word “input” is also used to describe “contextual” input that may not be directly provided by the user via the UI 1320. For example, user's interactions with the UI 1320 are analyzed using, e.g., natural language processing techniques, to determine context or intent of the user, which can be treated in a manner similar to “direct” user input.

Depending on the type of the user device 1302, the computer-readable media 1310 can also optionally include other functional components and data, such as other components and data 1322, which can include programs, drivers, etc., and the data used or generated by the functional components. In addition, the computer-readable media 1310 can also store data, data structures and the like, that are used by the functional components. Further, the user device 1302 can include many other logical, programmatic and physical components, of which those described are merely examples that are related to the discussion herein.

In at least one example, the computer-readable media 1310 can include additional functional components, such as an operating system 1324 for controlling and managing various functions of the user device 1302 and for enabling basic user interactions.

The communication interface(s) 1312 can include one or more interfaces and hardware components for enabling communication with various other devices, such as over the network(s) 1306 or directly. For example, communication interface(s) 1312 can enable communication through one or more network(s) 1306, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1306 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure can be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1302 can further include one or more input/output (I/O) devices 1314. The I/O devices 1314 can include speakers, a microphone, a camera, and various user controls (e.g., buttons, a joystick, a keyboard, a keypad, etc.), a haptic output device, and so forth. The I/O devices 1314 can also include attachments that leverage the accessories (audio-jack, USB-C, Bluetooth, etc.) to connect with the user device 1302.

In at least one example, user device 1302 can include a display 1316. Depending on the type of computing device(s) used as the user device 1302, the display 1316 can employ any suitable display technology. For example, the display 1316 can be a liquid crystal display, a plasma display, a light emitting diode display, an OLED (organic light-emitting diode) display, an electronic paper display, or any other suitable type of display able to present digital content thereon. In at least one example, the display 1316 can be an augmented reality display, a virtually reality display, or any other display able to present and/or project digital content. In some examples, the display 1316 can have a touch sensor associated with the display 1316 to provide a touchscreen display configured to receive touch inputs for enabling interaction with a graphic interface presented on the display 1316. Accordingly, implementations herein are not limited to any particular display technology. Alternatively, in some examples, the user device 1302 may not include the display 1316, and information can be presented by other means, such as aurally, haptically, etc.

In addition, the user device 1302 can include sensor(s) 1318. The sensor(s) 1318 can include a GPS device able to indicate location information. Further, the sensor(s) 1318 can include, but are not limited to, an accelerometer, gyroscope, compass, proximity sensor, camera, microphone, and/or a switch.

In some examples, the GPS device can be used to identify a location of a user. In at least one example, the location of the user can be used by the service provider 612, described above, to provide one or more services. That is, in some examples, the service provider 612 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 614 and/or for sending users 614 notifications regarding available appointments with merchant(s) located proximate to the users 614. In at least one example, location can be used for taking payments from nearby customers when they leave a geofence, or location can be used to initiate an action responsive to users 614 enter a brick-and-mortar store of a merchant. Location can be used in additional or alternative ways as well.

Additionally, the user device 1302 can include various other components that are not shown, examples of which include removable storage, a power source, such as a battery and power control unit, a barcode scanner, a printer, a cash drawer, and so forth.

In addition, in some examples, the user device 1302 can include, be connectable to, or otherwise be coupled to a reader device 1326, for reading payment instruments and/or identifiers associated with payment objects. In some examples, as described above, the reader device 1326 can plug in to a port in the user device 1302, such as a microphone port, a headphone port, an audio-jack, a data port, or other suitable port. In additional or alternative examples, the reader device 1326 can be coupled to the user device 1302 via another wired or wireless connection, such as via a Bluetooth®, BLE, and so on. The reader device 1326 can include a read head for reading a magnetic strip of a payment card, and further can include encryption technology for encrypting the information read from the magnetic strip. Additionally, or alternatively, the reader device 1326 can be an EMV payment reader, which in some examples, can be embedded in the user device 1302. Moreover, numerous other types of readers can be employed with the user device 1302 herein, depending on the type and configuration of the user device 1302.

The reader device 1326 can be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 1326 can include hardware implementation, such as slots, magnetic tracks, and rails with one or more sensors or electrical contacts to facilitate detection and acceptance of a payment instrument. That is, the reader device 1326 can include hardware implementations to enable the reader device 1326 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer can tap or hover his or her electronic device such as a smart phone running a payment application over a payment reader to complete a transaction via short-range communication) to obtain payment data associated with a customer. Additionally, or optionally, the reader device 1326 can also include a biometric sensor to receive and process biometric characteristics and process them as payment instruments, given that such biometric characteristics are registered with the payment service system 100 and connected to a financial account with a bank server.

The reader device 1326 can include processing unit(s), computer-readable media, a reader chip, a transaction chip, a timer, a clock, a network interface, a power supply, and so on. The processing unit(s) of the reader device 1326 can execute one or more components and/or processes to cause the reader device 1326 to perform a variety of functions, as set forth above and explained in further detail in the following disclosure. In some examples, the processing unit(s) can include a central processing unit (CPU), a graphics processing unit (GPU), a CPU and a GPU, or processing units or components known in the art. Additionally, each of the processing unit(s) can possess its own local memory, which also can store program components, program data, and/or one or more operating systems. Depending on the exact configuration and type of the reader device 1326, the computer-readable media can include volatile memory (such as RAM), non-volatile memory (such as ROM, flash memory, miniature hard drive, memory card, or the like), or some combination thereof. In at least one example, the computer-readable media of the reader device 1326 can include at least one component for performing various functions as described herein.

The reader chip can perform functionalities to control the operations and processing of the reader device 1326. That is, the reader chip can perform functionalities to control payment interfaces (e.g., a contactless interface, a contact interface, etc.), a wireless communication interface, a wired interface, a UI (e.g., a signal condition device (FPGA)), etc. Additionally, the reader chip can perform functionality to control the timer, which can provide a timer signal indicating an amount of time that has lapsed following a particular event (e.g., an interaction, a power-down event, etc.). Moreover, the reader chip can perform functionality to control the clock, which can provide a clock signal indicating a time. Furthermore, the reader chip can perform functionality to control the network interface, which can interface with the network(s) 1306, as described below.

Additionally, the reader chip can perform functionality to control the power supply. The power supply can include one or more power supplies such as a physical connection to AC power or a battery. Power supply can include power conversion circuitry for converting AC power and generating a plurality of DC voltages for use by components of reader device 1326. When power supply includes a battery, the battery can be charged via a physical power connection, via inductive charging, or via any other suitable method.

The transaction chip can perform functionalities relating to processing of payment transactions, interfacing with payment instruments, cryptography, and other payment-specific functionality. That is, the transaction chip can access payment data associated with a payment instrument and can provide the payment data to a POS terminal, as described above. The payment data can include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which can or may not match the number associated with the payment instrument), restrictions on what types of charges/debts can be made, etc. Additionally, the transaction chip can encrypt the payment data upon receiving the payment data.

It should be understood that in some examples, the reader chip can have its own processing unit(s) and computer-readable media and/or the transaction chip can have its own processing unit(s) and computer-readable media. In other examples, the functionalities of reader chip and transaction chip can be embodied in a single chip or a plurality of chips, each including any suitable combination of processing units and computer-readable media to collectively perform the functionalities of reader chip and transaction chip as described herein.

While, the user device 1302, which can be a POS terminal, and the reader device 1326 are shown as separate devices, in additional or alternative examples, the user device 1302 and the reader device 1326 can be part of a single device, which can be a battery-operated device. In such an example, components of both the user device 1302 and the reader device 1326 can be associated with the single device. In some examples, the reader device 1326 can have a display integrated therewith, which can be in addition to (or as an alternative of) the display 1316 associated with the user device 1302.

The server(s) 1304 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1304 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1304 can be located together or separately, and organized, for example, as virtual servers, server banks and/or server farms. The described functionality can be provided by the servers of a single merchant or enterprise or can be provided by the servers and/or services of multiple different customers or enterprises.

In the illustrated example, the server(s) 1304 can include one or more processors 1328, one or more computer-readable media 1330, one or more I/O devices 1332, and one or more communication interfaces 1334. Each processor 1328 can be a single processing unit or a number of processing units and can include single or multiple computing units or multiple processing cores. The processor(s) 1328 can be implemented as one or more microprocessors, microcomputers, microcontrollers, digital signal processors, central processing units, state machines, logic circuitries, and/or any devices that manipulate signals based on operational instructions. For example, the processor(s) 1328 can be one or more hardware processors and/or logic circuits of any suitable type specifically programmed or configured to execute the algorithms and processes described herein. The processor(s) 1328 can be configured to fetch and execute computer-readable instructions stored in the computer-readable media 1330, which can program the processor(s) 1328 to perform the functions described herein.

The computer-readable media 1330 can include volatile and nonvolatile memory and/or removable and non-removable media implemented in any type of technology for storage of information, such as computer-readable instructions, data structures, program components, or other data. Such computer-readable media 1330 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1304, the computer-readable media 1330 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1330 can be used to store any number of functional components that are executable by the processor(s) 1328. In many implementations, these functional components comprise instructions or programs that are executable by the processors 1328 and that, when executed, specifically configure the one or more processors 1328 to perform the actions attributed above to the service provider 612 and/or payment processing service. Functional components stored in the computer-readable media 1330 can optionally include a contextual data transfer component 1336, a training component 1338, and one or more other components and data 1340.

The contextual data transfer component 1336 can be configured to generate and/or determine context data associated with transactions to determine which currency(s) to use for payment. Additional details are provided above with reference to the contextual data transfer component 135 of FIG. 1.

The training component 1338 can be configured to train models using machine-learning mechanisms. For example, a machine-learning mechanism can analyze training data to train a data model (e.g., a “machine-trained model”) that generates an output, which can be a recommendation, a score, and/or another indication. In some examples, the machine-trained models can be trained on training data including historical transaction data associated with transactions conducted by a plurality of users of the payment service and context data associated with such transactions. In some examples, the machine-trained models generated by the training component 1338 can be utilized to determine whether a conversion between currencies should occur, when such a conversion should occur, how such a conversion should occur, and/or the like. In some examples, as described herein machine-trained models can be used to determine “optimal” currencies and/or conversion paths for payments. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained models can be stored in a datastore associated with the user device(s) 1302 and/or the server(s) 1304 for use at a time after the machine-trained models have been trained (e.g., at runtime).

The one or more other components and data 1340 can include programs, drivers, etc., and the data used or generated by the functional components. Further, the server(s) 1304 can include many other logical, programmatic and physical components, of which those described above are merely examples that are related to the discussion herein.

The one or more “components” referenced herein can be implemented as more components or as fewer components, and functions described for the components can be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that can generate useful data or other output using specified input(s). A component can or may not be self-contained. An application program (also called an “application”) can include one or more components, or a component can include one or more application programs that can be accessed over a network or downloaded as software onto a device (e.g., executable code causing the device to perform an action). An application program (also called an “application”) can include one or more components, or a component can include one or more application programs. In additional and/or alternative examples, the component(s) can be implemented as computer-readable instructions, various data structures, and so forth via at least one processing unit to configure the computing device(s) described herein to execute instructions and to perform operations as described herein.

In some examples, a component can include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally, or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The computer-readable media 1330 can additionally include an operating system 1342 for controlling and managing various functions of the server(s) 1304.

The communication interface(s) 1334 can include one or more interfaces and hardware components for enabling communication with various other devices, such as over the network(s) 1306 or directly. For example, communication interface(s) 1334 can enable communication through one or more network(s) 1306, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 1302 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 1304 can further be equipped with various I/O devices 1332. Such I/O devices 1332 can include a display, various UI controls (e.g., buttons, joystick, keyboard, mouse, touch screen, biometric or sensory input devices, etc.), audio speakers, connection ports and so forth.

In at least one example, the system 1300 can include a datastore 1344 that can be configured to store data that is accessible, manageable, and updatable. In some examples, the datastore 1344 can be integrated with the user device 1302 and/or the server(s) 1304. In other examples, as shown in FIG. 13, the datastore 1344 can be located remotely from the server(s) 1304 and can be accessible to the server(s) 1304. The datastore 1344 can comprise multiple databases and/or servers connected locally and/or remotely via the network(s) 1306.

In at least one example, the datastore 1344 can store user profiles or user account(s) such as the user account(s) 1104 of FIG. 11, which can include merchant profiles, customer profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a balance of the merchant, such as a balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

Furthermore, in at least one example, the datastore 1344 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1344 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention and can be included in more than one example of the present invention. In addition, such phrases do not necessarily refer to the same examples or to different examples.

If the specification states a component or feature “can,” “can,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The previous description is not to be taken in a limiting sense but is made merely for the purpose of describing the general principles of example embodiments. Reference throughout this specification to “one embodiment,” “an embodiment,” or similar language means that a particular feature, structure, or characteristic that is described in connection with the referenced embodiment is included in at least the referenced embodiment. Likewise, reference throughout this specification to “some embodiments” or similar language means that particular features, structures, or characteristics that are described in connection with the referenced embodiments are included in at least the referenced embodiments. Thus, appearances of the phrases “in one embodiment,” “in an embodiment,” “in some embodiments,” and similar language throughout this specification can, but do not necessarily, all refer to the same embodiment.

Further, the described features, structures, or characteristics of the present disclosure can be combined in any suitable manner in one or more embodiments. In the description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

In the following description, certain terminology is used to describe features of the disclosure. For example, in certain situations, the term “logic” is representative of hardware, firmware and/or software that is configured to perform one or more functions. As hardware, logic (or engine) can include circuitry having data processing or storage functionality. Examples of such circuitry can include, but are not limited or restricted to a microprocessor, one or more processor cores, a programmable gate array, a microcontroller, a controller, an application specific integrated circuit, wireless receiver, transmitter and/or transceiver circuitry, semiconductor memory, or combinatorial logic.

Logic can be software in the form of one or more software modules, such as executable code in the form of an executable application, an application programming interface (API), a subroutine, a function, a procedure, an applet, a servlet, a routine, source code, object code, a shared library/dynamic link library, or one or more instructions. These software modules can be stored in any type of a suitable non-transitory storage medium, or transitory storage medium (e.g., electrical, optical, acoustical or other form of propagated signals such as carrier waves, infrared signals, or digital signals). Examples of non-transitory storage mediums can include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code is stored in persistent storage.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

### EXAMPLE CLAUSES

A. A computer-implemented method comprising: maintaining, by a payment service, an account for a user, wherein the account is associated with at least a first fiat currency balance and a stablecoin balance; receiving, by the payment service, a payment request associated with a transaction between the user and another user, wherein the payment request identifies the account as a source of payment for the transaction and an amount of the transaction in a second fiat currency; dynamically determining, by the payment service and based on context data associated with the payment request, whether to utilize the first fiat currency balance or the stablecoin balance associated with the account for payment for the transaction; based at least in part on determining to use the first fiat currency balance associated with the account, processing, by the payment service, the transaction by sending the assets in the first fiat currency to another account associated with the other user, wherein the assets originated from the first fiat currency balance and an amount of the assets sent corresponds to the amount in the second fiat currency; and based at least in part on determining to utilize the stablecoin balance: determining, by the payment service, an amount in stablecoin that corresponds to the amount in the second fiat currency; converting, by the payment service, a portion of the stablecoin balance to the determined amount in stablecoin via one or more transactions with a cryptocurrency exchange system; decreasing, by the payment service, the stablecoin balance based at least in part on the conversion; and processing, by the payment service, the transaction by sending the assets in the second fiat currency to the other account associated with the other user.

B. The computer-implemented method of any of clauses A, wherein the payment request is received from a merchant, the merchant utilizes the second fiat currency, and the transaction is processed by sending the assets to another account associated with the merchant.

C. The computer-implemented method of any of clauses A or B, wherein the context data comprises one or more of user data, user preferences determined based on the user data, transaction data, trends or patterns determined from transaction data, geolocation data, time or date data, exchange rates, availability of currencies or blockchains associated with currencies, risk data, or third-party data availed via third-party integrations.

D. The computer-implemented method of any of clauses A-C, wherein conversion of the stablecoin balance to the second fiat currency is done by the payment service utilizing one or more internal ledgers.

E. A computer-implemented method comprising: maintaining, by a payment service, an account for a user, wherein the account is associated with one or more balances associated with one or more currencies, wherein each balance is associated with a different currency; receiving, by the payment service, a payment request associated with a transaction between the user and another user, wherein the payment request identifies the account as a source of payment for the transaction and an amount of the transaction in an indicated currency; dynamically determining, by the payment service and based on context data associated with at least one of the user, the other user, or the transaction, one or more currencies for settling a payment associated with the transaction; converting, by the payment service and based at least in part on at least one currency of the one or more currencies being different than the indicated currency, a portion of a balance of the one or more balances, associated with a particular currency, to the indicated currency using an intermediary; and processing, by the payment service, the transaction by transferring the converted assets to the other account associated with the other user.

F. The computer-implemented method of any of clauses E, wherein the dynamically determining the one or more currencies for settling the payment is based at least in part on using a machine-trained model.

G. The computer-implemented method of any of clauses E or F, wherein the machine-trained model is trained based at least in part on context data and transaction data associated with a plurality of historical transactions associated with users of a payment service.

H. The computer-implemented method of any of clauses E-G, wherein the context data comprises one or more of user data, user preferences determined based on the user data, transaction data, trends or patterns determined from transaction data, geolocation data, time or date data, exchange rates, availability of currencies or blockchains associated with currencies, risk data, or third-party data availed via third-party integrations.

I. The computer-implemented method of any of clauses E-H, wherein the user comprises a customer, the other user comprises a merchant, and the transaction is associated with a point-of-sale transaction.

J. The computer-implemented method of any of clauses E-I, wherein the user and the other user are peers and the transaction comprises a peer-to-peer transaction.

K. The computer-implemented method of any of clauses E-J, wherein converting the portion of the balance, associated with a particular currency, to the indicated currency comprises: determining, at the time of the payment request, a conversion rate between the particular currency and the indicated currency; determining, based on the conversion rate, an amount of assets associated with the balance to withdraw from the balance; withdrawing the amount of assets from the balance associated with the account; and associating the amount of assets withdrawn from the balance with another balance associated with the payment service.

L. The computer-implemented method of any of clauses E-K, wherein the balance and the other balance are each associated with an internal ledger system to facilitate a near-real-time conversion.

M. A non-transitory computer readable medium storing a program causing a computer to execute a process comprising: maintaining, by a payment service, an account for a user, wherein the account is associated with one or more balances associated with one or more currencies, wherein each balance is associated with a different currency; receiving, by the payment service, a payment request associated with a transaction between the user and another user, wherein the payment request identifies the account as a source of payment for the transaction and an amount of the transaction in an indicated currency; intelligently determining, by the payment service and based on context data associated with at least one of the user, the other user, or the transaction, one or more currencies for settling a payment associated with the transaction; converting, by the payment service and based at least in part on at least one currency of the one or more currencies being different than the indicated currency, a portion of a balance of the one or more balances, associated with a particular currency, to the indicated currency via an intermediary; and processing, by the payment service, the transaction by transferring the converted assets to the other account associated with the other user.

N. The program of any of clauses M, wherein the intelligently determining the one or more currencies for settling the payment is based at least in part on using a machine-trained model.

O. The program of clause M or N, wherein the machine-trained model is trained based at least in part on context data and transaction data associated with a plurality of historical transactions associated with users of a payment service.

P. The program of any of clauses M-O, wherein the context data comprises one or more of user data, user preferences determined based on the user data, transaction data, trends or patterns determined from transaction data, geolocation data, time or date data, exchange rates, availability of currencies or blockchains associated with currencies, risk data, or third-party data availed via third-party integrations.

Q. The program of any of clauses M-P, wherein converting the portion of the balance, associated with a particular currency, to the indicated currency comprises: determining, at the time of the payment request, a conversion rate between the particular currency and the indicated currency; determining, based on the conversion rate, an amount of assets associated with the balance to withdraw from the balance; withdrawing the amount of assets from the balance associated with the account; and associating the amount of assets withdrawn from the balance with another balance associated with the payment service.

R. The program of clause Q, wherein the balance and the other balance are each associated with an internal ledger system to facilitate a near-real-time conversion.

S. The program of clause Q or R, wherein the intermediary comprises stablecoin and wherein the other balance is a stablecoin balance.

T. The program of any of clauses Q-S, wherein converting the portion of the balance, associated with a particular currency, to the indicated currency further comprises converting the stablecoin into the indicated currency prior to transferring the converted assets to the account associated with the other user.

While represented as systems, methods, and programs, any of clauses A-T can be implemented by any one of a system, method, program, or non-transitory computer-readable media.

1. A computer-implemented method comprising:
maintaining, by a processing system, a record for a user, wherein the record is associated with at least a first asset and a second asset;
receiving, by the processing system, a request associated with an exchange between the user and another user, wherein the request identifies the record as a source for the exchange and an amount of the exchange expressed in a third asset;
dynamically determining, by the processing system and based on an objective analysis of context data associated with the request, an optimal conversion path for completing the exchange, wherein the optimal conversion path is determined based on processing capabilities of one or more blockchain networks associated with the first asset and the second asset and specifies whether to utilize the first asset or the second asset associated with the record for completing the exchange;
based at least in part on determining to utilize the first asset associated with the record, processing, by the processing system, the exchange according to the optimal conversion path and by sending a portion of the first asset to another record associated with the other user, wherein the portion of the first asset sent corresponds to the third asset; and
based at least in part on determining to utilize the second asset:
determining, by the processing system, an amount of the second asset that corresponds to the third asset;
converting, by the processing system, a portion of the second asset to the amount corresponding to the third asset via one or more exchanges with a blockchain-based exchange system;
decreasing, by the processing system, a balance of the second asset based at least in part on the conversion; and
processing, by the processing system and according to the optimal conversion path, the exchange by sending the amount corresponding to the third asset to the other record associated with the other user.

2. The computer-implemented method of claim 1, wherein the context data comprises one or more of geolocation data, time data, or date data.

3. The computer-implemented method of claim 1, wherein
the objective analysis for dynamic determination of the optimal conversion path is performed using one or more trained machine learning models, and
the one or more trained machine learning models are trained based at least in part on context data and exchange data associated with a plurality of historical exchanges associated with users of a processing system.

4. (canceled)

5. The computer-implemented method of claim 1, wherein the second asset is a digital asset and is different from the first asset and the third asset.

6. The computer-implemented method of claim 1, wherein the processing system processes the exchange as part of a batch processing of multiple exchanges.

7. The computer-implemented method of claim 1, wherein the objective analysis is performed in real-time.

8. A processing system comprising:
one or more memories having computer-readable instructions stored therein; and
one or more processors configured to execute the computer-readable instructions to:
maintain a record for a user, wherein the record is associated with at least a first asset and a second asset;
receive a request associated with an exchange between the user and another user, wherein the request identifies the record as a source for the exchange and an amount of the exchange expressed in a third asset;
dynamically determine, based on an objective analysis of context data associated with the request, an optimal conversion path for completing the exchange, wherein the optimal conversion path is determined based on processing capabilities of one or more blockchain networks associated with the first asset and the second asset and specifies whether to utilize the first asset or the second asset associated with the record for completing the exchange;
based at least in part on determining to utilize the first asset associated with the record, process the exchange according to the optimal conversion path and by sending a portion of the first asset to another record associated with the other user, wherein the portion of the first asset sent corresponds to the third asset; and
based at least in part on determining to utilize the second asset:
determine an amount of the second asset that corresponds to the third asset;
convert a portion of the second asset to the amount corresponding to the third asset via one or more exchanges with a blockchain-based exchange system;
decrease a balance of the second asset based at least in part on the conversion; and
process, according to the optimal conversion path, the exchange by sending the amount corresponding to the third asset to the other record associated with the other user.

9. The processing system of claim 8, wherein the context data comprises one or more of exchange rates and availability of assets or blockchains associated with the assets.

10. The processing system of claim 8, wherein
the objective analysis for dynamic determination of the optimal conversion path is performed using one or more trained machine learning models, and
the one or more trained machine learning models are trained based at least in part on context data and exchange data associated with a plurality of historical exchanges associated with users of a processing system.

11. (canceled)

12. The processing system of claim 8, wherein the second asset is a digital asset and is different from the first asset and the third asset.

13. The processing system of claim 8, wherein the processing system processes the exchange as part of a batch processing of multiple exchanges.

14. The processing system of claim 8, wherein the objective analysis is performed in real-time.

15. One or more non-transitory computer-readable media comprising computer-readable instructions, which when executed by one or more processors of a processing system, cause the processing system to:
maintain a record for a user, wherein the record is associated with at least a first asset and a second asset;
receive a request associated with an exchange between the user and another user, wherein the request identifies the record as a source for the exchange and an amount of the exchange expressed in a third asset;
dynamically determine, based on an objective analysis of context data associated with the request, an optimal conversion path for completing the exchange, wherein the optimal conversion path is determined based on processing capabilities of one or more blockchain networks associated with the first asset and the second asset and specifies whether to utilize the first asset or the second asset associated with the record for completing the exchange;
based at least in part on determining to utilize the asset associated with the record, process the exchange according to the optimal conversion path and by sending a portion of the first asset to another record associated with the other user, wherein the portion of the first asset sent corresponds to the third asset; and
based at least in part on determining to utilize the second asset:
determine an amount of the second asset that corresponds to the third asset;
convert a portion of the second asset to the amount corresponding to the third asset via one or more exchanges with a blockchain-based exchange system;
decrease a balance of the second asset based at least in part on the conversion; and
process, according to the optimal conversion path, the exchange by sending the amount corresponding to the third asset to the other record associated with the other user.

16. The one or more non-transitory computer-readable media of claim 15, wherein the context data comprises one or more of risk data and third-party data availed via third-party integrations.

17. The one or more non-transitory computer-readable media of claim 15, wherein
the objective analysis for dynamic determination of the optimal conversion path is performed using one or more trained machine learning models, and
the one or more trained machine learning models are trained based at least in part on context data and exchange data associated with a plurality of historical exchanges associated with users of a processing system.

18. (canceled)

19. The one or more non-transitory computer-readable media of claim 15, wherein the second asset is a digital asset and is different from the first asset and the third asset.

20. The one or more non-transitory computer-readable media of claim 15, wherein
the processing system processes the exchange as part of a batch processing of multiple exchanges; and
the objective analysis is performed in real-time.

21. The computer-implemented method of claim 1, wherein the optimal conversion path is determined based on the processing capabilities of one or more blockchain networks and availability of the one or more blockchain networks.

22. The computer-implemented method of claim 21, wherein the optimal conversion path specifies a timing for completing the exchange based on the availability of the one or more blockchain networks.

23. The computer-implemented method of claim 22, wherein the optimal conversion path specifies how to use the first asset and the second asset for completing the exchange.
